(19) United States
(12) Patent Application Publication
(10) Pub. No.: US 2025/0229915 A1
(43) Pub. Date: Jul. 17, 2025

(54) VEHICLE FOR OBTAINING LINEAR MOMENTUM WITHOUT THROWING THE MASS FROM THE VEHICLE IN THE SPACE

(71) Applicant: VIVEK KUMAR SINGH, JAMSHEDPUR (IN)

(72) Inventor: VIVEK KUMAR SINGH, JAMSHEDPUR (IN)

(21) Appl. No.: 18/701,746

(22) PCT Filed: Jan. 13, 2022
(86) PCT No.: PCT/IB2022/050242

§ 371 Date: Apr. 16, 2024

(30) Foreign Application Priority Data
Oct. 28, 2021 (IN) 202131049384
Jan. 13, 2022 (WO) PCT/IB2022/050242

(51) Int. Cl. B64G 1/40

(52) U.S. Cl. CPC B64G 1/409

(57) ABSTRACT

A vehicle for obtains linear momentum without throwing the mass from the vehicle in the space, comprising of a power source 13; a rigid base 1; a motor 3A and a motor 3B fitted in the rigid basel; a shaft 4A for the motor 3A, and a shaft 4B for the motor 3B; an adjuster 6A fixed with the shaft 4A, and an adjuster 6B fixed with the shaft 4B, the adjuster 6A is the first part of a rotor blade 5A, and the adjuster 6B is the first part of a rotor blade 5B, the second part of the rotor blade 5A is a blade 7A, and the second part of the rotor blade 5B is a blade 7B; a rigid body 10 fixed to the end of the rigid base 1; a thrust structure 8A, a thrust structure 8B, a thrust structure 8C, and a thrust structure 8D fixed in the rigid body 10, at the start the thrust structures 8A and 8D give linear motion to the blades 7A and 7B, respectively, after getting the linear motion, the blades 7A and 7B are travelling; an electromagnet 6AE and an electromagnet 6BE present on the outer surface of the adjusters 6A and 6B, respectively, after travelling, the blades 7A and 7B stick with the electromagnets 6AE and 6BE, respectively, now the blade 7A and the adjuster 6A joined via the electromagnet 6AE, and the blade 7B and the adjuster 6B joined via the electromagnet 6BE, after joining, the blades 7A and 7B start the circular motion, wherein the circular motion of the blades 7A and 7B generates centripetal reaction force.

### EARLIEST PRIORITY DATE

This Application claims priority from a patent application filed in India having Patent Application No. 202131049384, filed on Oct. 28, 2021 and titled “VEHICLE FOR OBTAINING LINEAR MOMENTUM WITHOUT THROWING THE MASS FROM THE VEHICLE IN THE SPACE.” and a PCT Application no. PCT/IB2022/050242 filed on Jan. 13, 2022, and titled “VEHICLE FOR OBTAINING LINEAR MOMENTUM WITHOUT THROWING THE MASS FROM THE VEHICLE IN THE SPACE.”

### FIELD OF INVENTION

This invention relates to the space shuttle/vehicle, specifically to how the space shuttle/vehicle obtains the linear momentum without throwing the mass (like gas etc.) from itself (space shuttle/vehicle) in the space.

### BACKGROUND ART

To get the linear momentum in the space, a space shuttle/vehicle throws some mass from itself in the opposite direction from travel.

### Technical Problem

A space shuttle/vehicle gets the linear momentum by throwing some mass from itself (space shuttle/vehicle) in the space, for this reason, the space shuttle/vehicle requires a large amount of throwing mass. A space shuttle/vehicle always needs to throw the mass to get the linear momentum; this requirement blocks its (space shuttle/vehicle) ability to achieve peak speed compared to space distances.

### SUMMARY OF INVENTION

This invention gives a vehicle/space shuttle that obtains linear momentum without throwing the mass from itself (vehicle) in the space. To gain linear momentum without throwing the mass, this vehicle generates centripetal reaction force (reactive centrifugal force). This vehicle starts generating centripetal reaction force when the circular motion of the blades (objects) starts. Finally, the circular motion of the blades ends to achieve the linear momentum for the vehicle.

### Advantageous Effects of Invention

It will provide a vehicle that obtains the linear momentum without throwing the mass from itself (vehicle) in the space. Since no throwing mass is required to gain the linear momentum, therefore the vehicle will achieve extreme speed.
It will provide a vehicle that will be used several times in the space.
It will provide a vehicle that will use solar energy in the space as a fuel option.

### BRIEF DESCRIPTION OF ACCOMPANYING DRAWINGS

FIG. 1A is a diagrammatic representation of the presently invented vehicle in the 3D SE isometric wireframe view. And, FIG. 1A shows the 3D SE isometric view of the vehicle when the blades 7A and 7B start a circular motion; in the first cycle. And, FIG. 1A shows the 3D SE isometric view of the vehicle when the blades 7A and 7B complete the half-circle trip; in the second cycle.

FIG. 1B is a diagrammatic representation of the presently invented vehicle in the 3D SE isometric solid view.

FIG. 1C shows the adjusters 6A and 6B in the 3D SE isometric view.

FIG. 1D shows the adjuster 6A, adjuster 6B and electromagnet 6AE in the 3D SE 10 isometric view.

FIG. 1E shows the adjuster 6A, adjuster 6B and electromagnet 6BE in the 3D SW isometric view.

FIG. 1F shows the rotor blades 5A and 5B in the 3D SE isometric view.

FIG. 1G shows the vehicle in the 3D SE isometric view with dashed circle and dashed rectangles.

FIG. 1H shows the enlarged view of a dashed rectangle 1H in the 3D SE isometric view.

FIG. 1I shows the enlarged view of a dashed rectangle 1I in the 3D SE isometric view.

FIG. 1J shows the enlarged view of a dashed circle 1J in the 3D SE isometric view.

FIG. 1K shows the thrust structure 8A and electromagnet 8AE in the 3D SE isometric view.

FIG. 2 shows the 3D SE isometric view of the vehicle at the beginning of the first cycle. And, FIG. 2 shows the 3D SE isometric view of the vehicle, after the blades 7A and 7B joined with the vehicle; in the second cycle.

FIG. 3 shows the 3D SE isometric view of the vehicle when the blades 7A and 7B are pushed by the thrust structures 8A and 8D, respectively; in the first cycle.

FIG. 4 shows the 3D SE isometric view of the vehicle when each blade 7A and 7B is in straight-line motion towards −Y-axis; in the first cycle.

FIG. 5 shows the 3D SE isometric view of the vehicle when the blades 7A and 7B are in the circular motion; in the first cycle.

FIG. 6 shows the 3D SE isometric view of the vehicle when the blades 7A and 7B complete the half-circle trip; in the first cycle. And, FIG. 6 shows the 3D SE isometric view of the vehicle when the blades 7A and 7B start a circular motion; in the second cycle.

FIG. 7 shows the path of blades' 7A and 7B half-circle travel with some angles.

FIG. 8 shows the 3D SE isometric view of the vehicle when the blades 7A and 7B separated; in the first cycle.

FIG. 9 shows the 3D SE isometric view of the vehicle when each blade 7A and 7B is in straight-line motion towards +Y-axis; in the first cycle.

FIG. 10 shows the 3D SE isometric view of the vehicle, after the blades 7A and 7B joined with the vehicle; in the first cycle. And, FIG. 10 shows the 3D SE isometric view of the vehicle at the beginning of the second cycle.

FIG. 11A shows the centre of mass 11 of the shaft, two blades and three blades.

FIG. 11B shows the centre of mass 11 of each blade 7A and 7B.

FIG. 12A shows the direction and magnitude of the centripetal reaction force produced by the blades 7A and 7B at certain angles towards the X-axis.

FIG. 12B shows the direction and magnitude of the centripetal reaction force produced by the blades 7A at angle 1800 and 7B at angle 3600 towards the X-axis.

FIG. 12C shows the direction and magnitude of the centripetal reaction force produced by the blades 7A at angle 2100 and 7B at angle 3300 towards the X-axis.

FIG. 12D shows the direction and magnitude of the centripetal reaction force produced by the blades 7A and 7B at certain angles (in the full-circle journey) towards the X-axis.

FIG. 13A shows the direction and magnitude of the centripetal reaction force produced by the blades 7A and 7B at certain angles towards the Y-axis.

FIG. 13B shows the direction and magnitude of the centripetal reaction force produced by the blades 7A at angle 1800 and 7B at angle 3600 towards the Y-axis.

FIG. 13C shows the direction and magnitude of the centripetal reaction force produced by the blades 7A at angle 2100 and 7B at angle 3300 towards the Y-axis.

FIG. 13D shows the direction and magnitude of the centripetal reaction force produced by the blades 7A and 7B at certain angles in the full-circle journey towards the Y-axis.

FIG. 14 shows all the linear momentum provided to the vehicle by the blades 7A and 7B (due to the centripetal reaction force) during the half-circle travel; in the first cycle.

FIG. 15A is a diagrammatic representation of the slightly modified invented vehicle in the 3D SE isometric view. And, FIG. 15A shows the 3D SE isometric view of the vehicle when the blades 7A and 7B start a circular motion; in the first cycle of “full-circle split”.

FIG. 15B is a diagrammatic representation of the slightly modified invented vehicle in the 3D NE isometric view.

FIG. 16 shows the 3D SE isometric view of the vehicle at the beginning of the first cycle of “full-circle split”. And, FIG. 16 shows the 3D SE isometric view of the vehicle, after the blades 7A and 7B joined with the vehicle; in the second cycle of “full-circle split”.

FIG. 17 shows the 3D SE isometric view of the vehicle when the blades 7A and 7B are pushed by the thrust structures 8A and 8D, respectively; in the first cycle of “full-circle split”.

FIG. 18 shows the 3D SE isometric view of the vehicle when the blades 7A and 7B are in the circular motion; in the first cycle of “full-circle split”.

FIG. 19 shows the 3D SE isometric view of the vehicle when the blades 7A and 7B separated; in the first cycle of “full-circle split”.

FIG. 20 shows the 3D SE isometric view of the vehicle, after the blades 7A and 7B joined with the vehicle; in the first cycle of “full-circle split”.

FIG. 21 shows the 3D SE isometric view of the vehicle when the blades 7A and 7B are pushed by the thrust structures 8B and 8C, respectively; in the second cycle of “full-circle split”.

FIG. 22 shows the 3D SE isometric view of the vehicle when the blades 7A and 7B are pushed by the thrust structures 8B and 8C, respectively; in the second cycle.

FIG. 23 shows the 3D SE isometric view of the vehicle when the blades 7A and 7B separated; in the second cycle.

FIG. 24 shows the 3D SE isometric view of the vehicle when the adjusters 6A and 6B start pulling the blades 7A and 7B, respectively; in the first cycle of “variable radius”.

FIG. 25 shows the 3D SE isometric view of the vehicle when the adjusters 6A and 6B have decreased the blades' 7A and 7B radius, respectively; in the first cycle of “variable radius”.

FIG. 26 shows the 3D SE isometric view of the vehicle when the blades 7A and 7B complete the half-circle trip, and the adjusters 6A and 6B start pushing the blades 7A and 7B, respectively; in the first cycle of “variable radius”.

FIG. 27 shows all the linear momentum provided to the vehicle by the blades 7A and 7B (due to the centripetal reaction force) during the half-circle travel; in the first cycle of “variable radius”.

FIG. 28 shows the 3D SE isometric view of the vehicle when it starts rotating in its centre.

FIG. 29 shows the 3D SE isometric view of the vehicle after rotating until a half-circle.

### REFERENCE NUMERALS IN DRAWINGS

1—Rigid base
2—Bearings
3A and 3B—Motors
4A and 4B—Shafts
5A and 5B—Rotor blades
6A and 6B—Adjusters. The adjusters 6A and 6B are the first part of the rotor blades 5A and 5B, respectively
6AE and 6BE—Electromagnets. The electromagnets 6AE and 6BE are present on the outer surface of the adjusters 6A and 6B, respectively
7A and 7B—Blades. The blades 7A and 7B are the second part of the rotor blades 5A and 5B, respectively
8A, 8B, 8C, and 8D—Thrust structures. These thrust structures 8A, 8B, 8C, and 8D are used to give linear motion to the blade 7A or blade 7B
8AE, 8BE, 8CE, and 8DE—Electromagnets. The electromagnets 8AE, 8BE, 8CE and 8DE are present on the outer surface of the thrust structures 8A, 8B, 8C, and 8D, respectively
8BR and 8CR—Rigid bodies
9A and 9B—Lock structures. These lock structures 9A and 9B are used to lock or unlock the shafts 4A and 4B, respectively
10—Rigid body. This rigid body 10 is fixed to the end of the rigid base 1
11—Centre of mass
12—Rotational centre
13—Power source
1H, 1I and 1J—Enlarged figures of vehicle's parts

### DETAILED DESCRIPTION

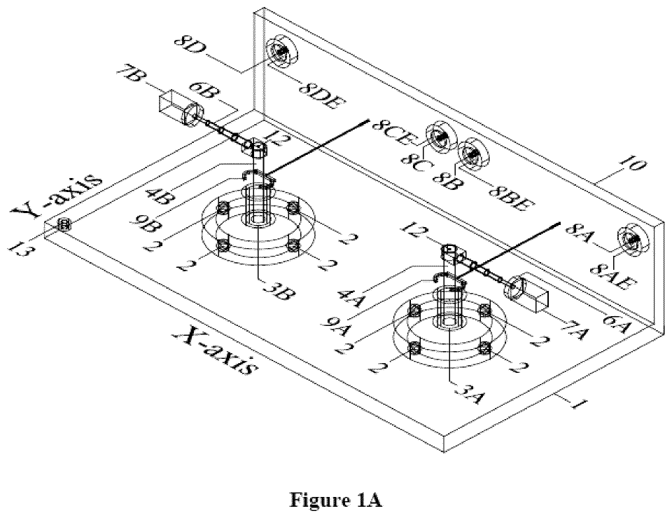

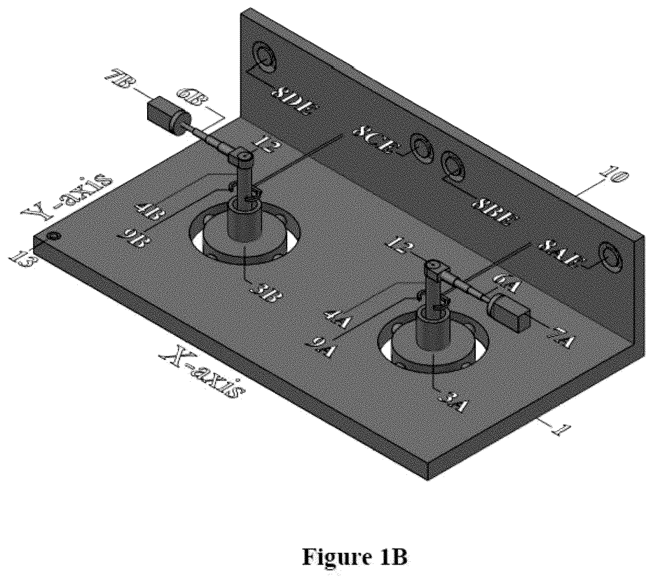

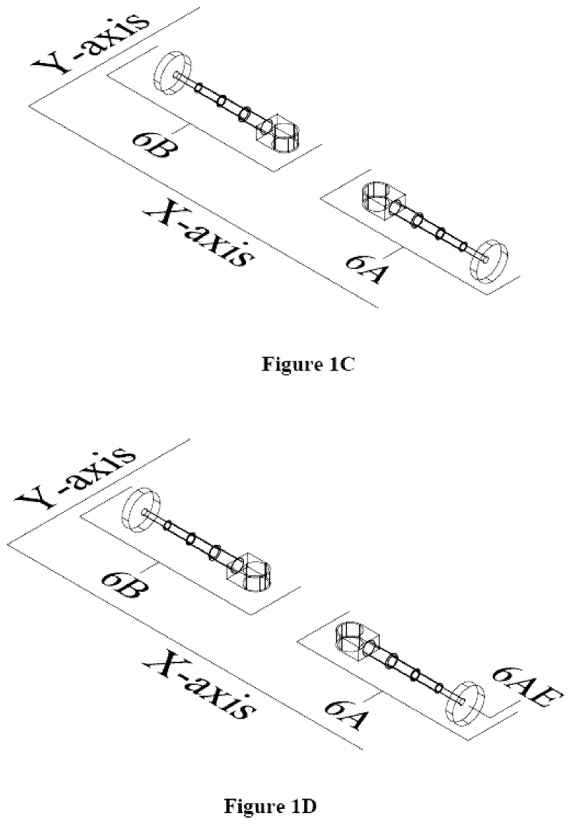

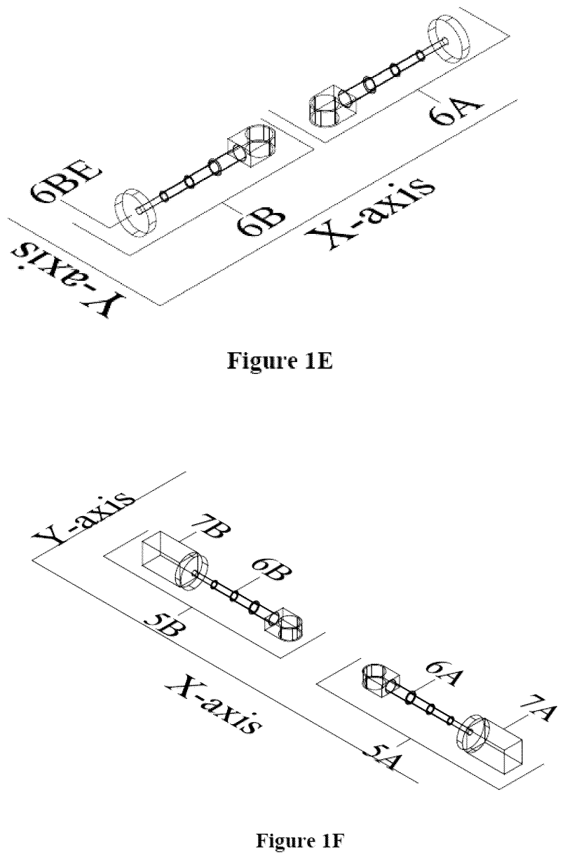

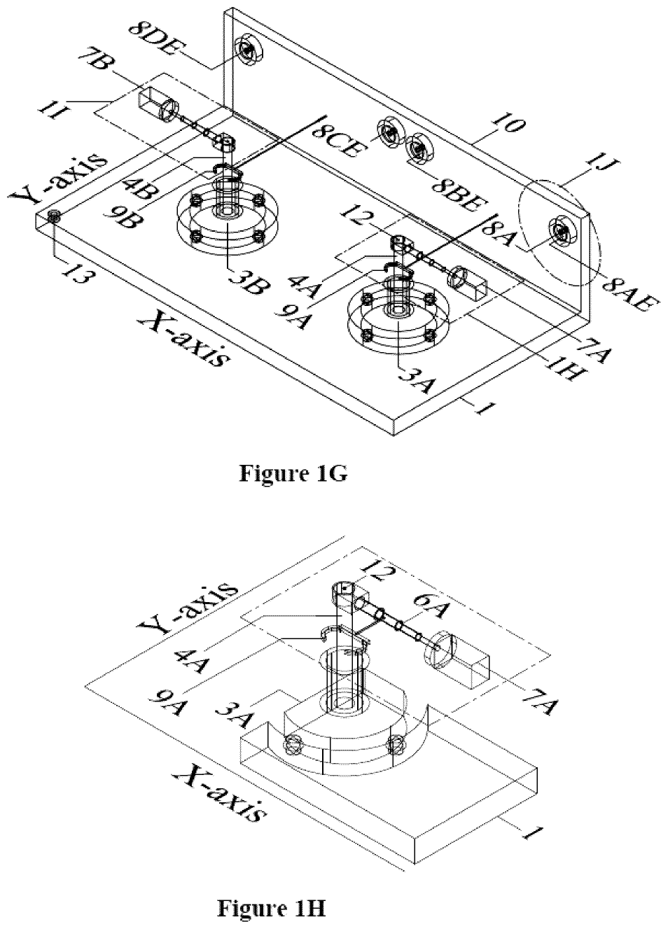

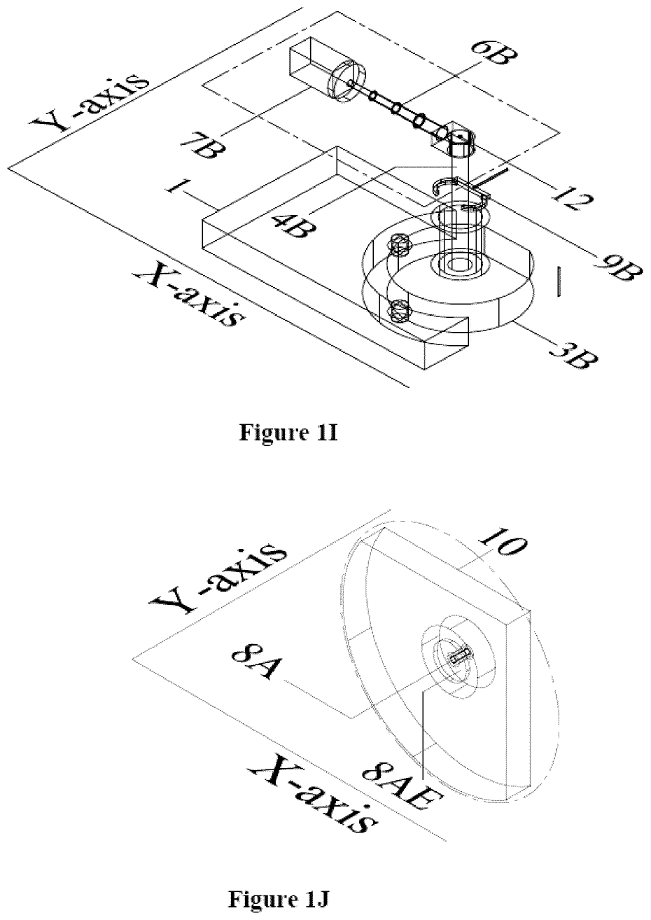

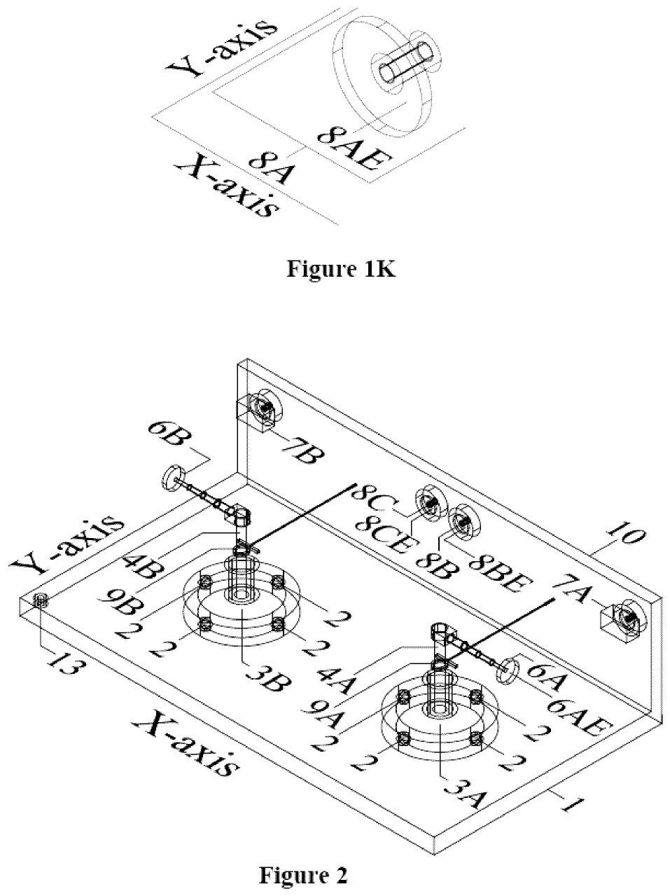

The drawing of the presently invented vehicle is illustrated in FIG. 1A (3D SE isometric wireframe view) and 1B (3D SE isometric solid view). The vehicle has a rigid base 1. Motors 3A and 3B have been fitted in the rigid base1. Motors 3A, 3B are free to rotate with the help of bearings 2. A power source 13 is present in the rigid base1.

The motors 3A and 3B have shafts 4A and 4B, respectively. The adjusters 6A and 6B have been fixed with shafts 4A and 4B, respectively. In FIG. 1C, only the adjusters 6A and 6B are shown in the 3D SE isometric view.

FIGS. 1A-1F—An electromagnet 6AE (see FIG. 1D shown in the 3D SE isometric view) is present on the adjuster's 6A outer surface. Similarly, an electromagnet 6BE (see FIG. 1E shown in the 3D SW isometric view) is present on the adjuster's 6B outer surface. The adjusters 6A and 6B are the first part of the rotor blades 5A and 5B, respectively (see FIG. 1F shown in the 3D SE isometric view).

The rotor blades 5A and 5B are in two-part (see FIG. 1F shown in the 3D SE isometric view). The second part of rotor blade 5A is blade 7A. The second part of rotor blade 5B is blade 7B. The mass of each blade 7A and 7B is equal to M. The mass of the adjusters 6A and 6B is negligible, compared to the blades 7A and 7B. The rotor blades 5A and 5B and blades 7A and 7B can be called anything. The adjusters 6A and 6B are used to increase or decrease the radius of blades 7A and 7B, respectively. The rotational centre 12 of each blade 7A and 7B is shown by a dot in some of the figures see FIGS. 1A and 1B.

Blades 7A and 7B have a nature of joining with the electromagnet. The adjuster 6A and blade 7A have been joined by the electromagnet 6AE. Similarly, the adjuster 6B and blade 7B have been joined by the electromagnet 6BE.

FIGS. 1G-1I—For a clear understanding of the vehicle, FIGS. 1G, 1H and 1I were added.

FIG. 1G shows the vehicle in the 3D SE isometric view with dashed circle 1J and dashed rectangles 1H, 1I. FIG. 1H shows the enlarged view of 1H. In FIG. 1H, we see the adjuster 6A, blade 7A, shaft 4A, motor 3A and rotational centre 12. FIG. 1I shows the enlarged view of 1I. In FIG. 1I, we see the adjuster 6B, blade 7B, shaft 4B, motor 3B and rotational centre 12.

FIGS. 1A, 1B, and 1K—The rigid body 10 has been fixed to the end of the rigid base 1. Thrust structures 8A, 8B, 8C, and 8D have been fixed in the rigid body 10. The thrust structures 8A, 8B, 8C, and 8D are used to give linear motion to the blade 7A or blade 7B. The electromagnets 8AE, 8BE, 8CE and 8DE are present on the outer surface of the thrust structures 8A, 8B, 8C, and 8D, respectively. FIG. 1K shows the thrust structure 8A with its electromagnet 8AE separately for greater clarity. All thrust structures 8A, 8B, 8C, and 8D are identical.

FIGS. 1G and 1J—For a clear understanding of the vehicle, FIGS. 1G and 1J were added. FIG. 1G shows the vehicle in the 3D SE isometric view with dashed circle 1J. FIG. 1J shows the enlarged view of 1J. In FIG. 1J, we see the thrust structure 8A and its electromagnet 8AE.

FIGS. 1A, 1B, 1G, 1H and 1I—Lock structures 9A and 9B have been fixed in the rigid body 10. The lock structures 9A and 9B are used to lock or unlock the shafts 4A and 4B, respectively (when there is a need to do so). The mass of shafts 4A and 4B is negligible, compared to the blades 7A and 7B.

### Operation—FIGS. 1A, 2-10, 11A, 11B, 12A, 12B, 12C, 13A, 13B, 13C and 14—Preferred Embodiment (Half-Circle Split)

FIG. 2—In the beginning, blades 7A and 7B, adjusters 6A and 6B, rigid base 1, rigid body 10, thrust structures 8A, 8B, 8C, and 8D and X-axis are parallel. The blades 7A and 7B are near the thrust structures 8A and 8D, respectively. The electromagnets 8AE, 8BE, 8CE and 8DE are off (not operational). Shafts 4A and 4B have been locked (fix in place) by the lock structures 9A and 9B, respectively.

The power source 13 turns on. The first cycle of this operation (half-circle split) begins.

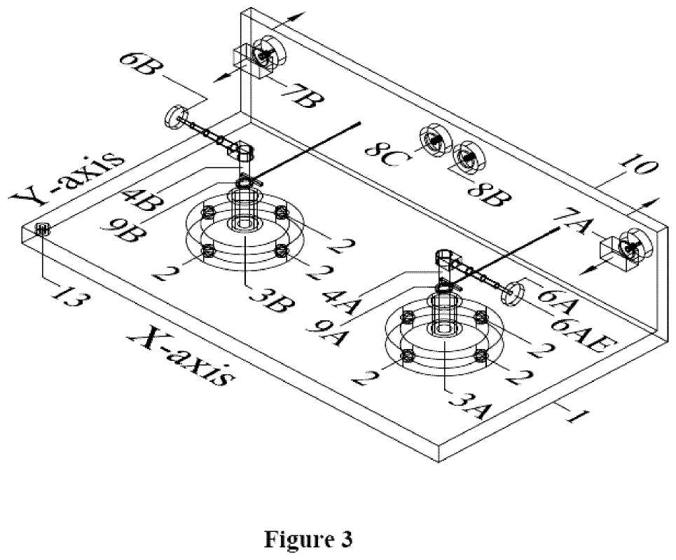

FIG. 3—The blades 7A and 7B are pushed by the thrust structures 8A and 8D, respectively, towards −Y-axis. As a result, each blade 7A and 7B starts the linear motion with linear velocity V (−Y-axis) and linear momentum MV (−Y-axis). By the law of conservation of momentum, the vehicle gets linear momentum of 2 MV (+Y-axis). Here we see that the thrust structures 8A and 8D give linear motion to the blades 7A and 7B, respectively.

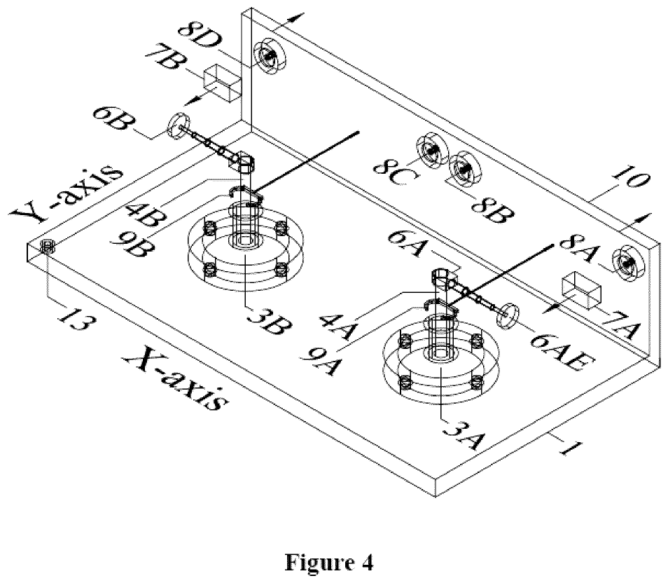

FIG. 4—After getting the linear motion, the blades 7A and 7B are travelling. Each blade 7A and 7B is travelling with linear velocity −V (Y-axis). The electromagnets 6AE and 6BE have become operational. Electromagnets 6AE and 6BE are ready to catch the blades 7A and 7B, respectively. The lock structures 9A and 9B have unlocked the shafts 4A and 4B, respectively.

FIG. 1A—After travelling, the blades 7A and 7B stick with the electromagnets 6AE and 6BE, respectively. Now the blade 7A and adjuster 6A joined via electromagnet 6AE, and the blade 7B and adjuster 6B joined via electromagnet 6BE. Each blade 7A and 7B joined at a distance R from the centre of rotation 12.

By the law of conservation of linear momentum—

Currently, the total linear momentum of the vehicle (after the joining of the blades 7A and 7B with the adjusters 6A and 6B)=Linear momentum of the vehicle+Linear momentum of the blades 7A and 7B=+2MV−MV−MV=0 . . . [LM1].

After joining, the blades 7A and 7B start the circular motion. The circular motion/angular momentum of the blades 7A and 7B generate centripetal reaction force. And, from the law of conservation of angular momentum—

Angular momentum of the blade 7A=mass*linear velocity*radius=MVR (in a clockwise direction).

Angular momentum of the blade 7B=MVR (in an anti-clockwise direction).

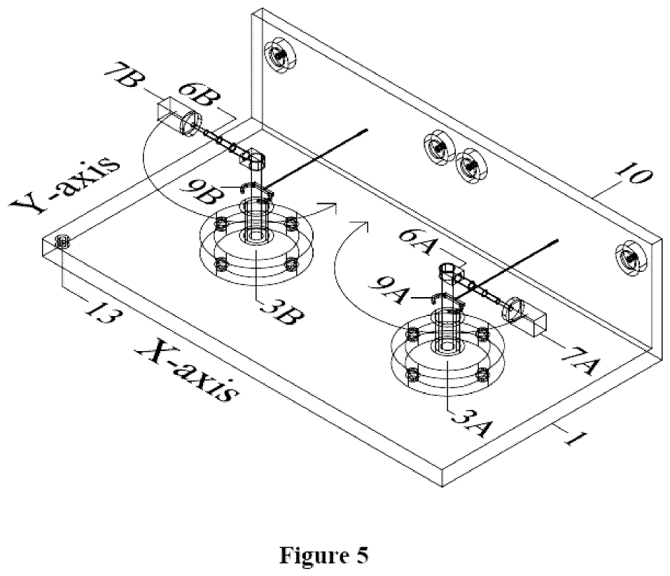

FIG. 5—The lock structures 9A and 9B are currently unlocked, and the blades 7A and 7B are in the circular motion. Each blade 7A and 7B stays on circular motion with speed V.

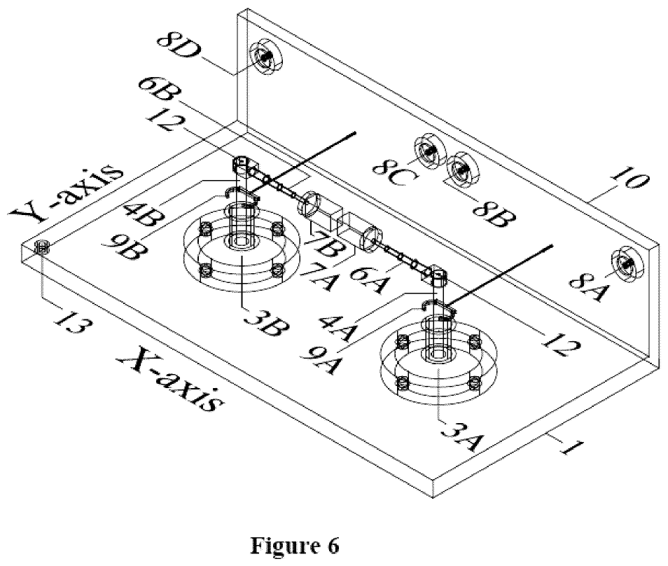

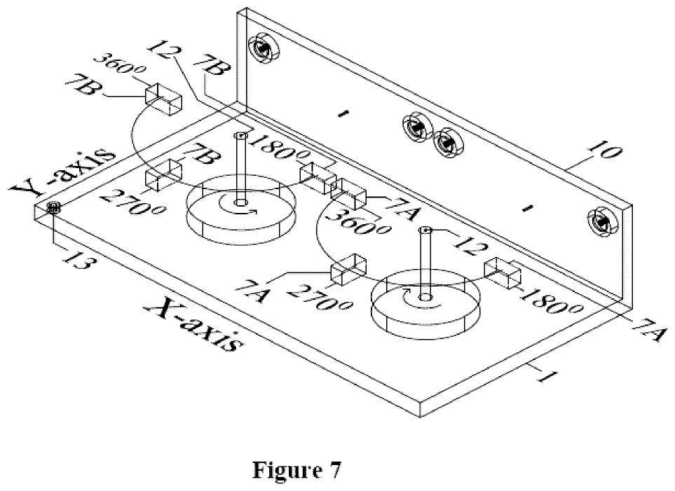

FIGS. 6 and 7—Blades 7A and 7B have travelled the half-circle till angle 3600 and angle 1800, respectively. Here, the blades' 7A and 7B instantaneous velocity becomes the opposite of the start=+V (Y-axis). FIG. 7 shows the path of blades' 7A and 7B half-circle travel with some angles.

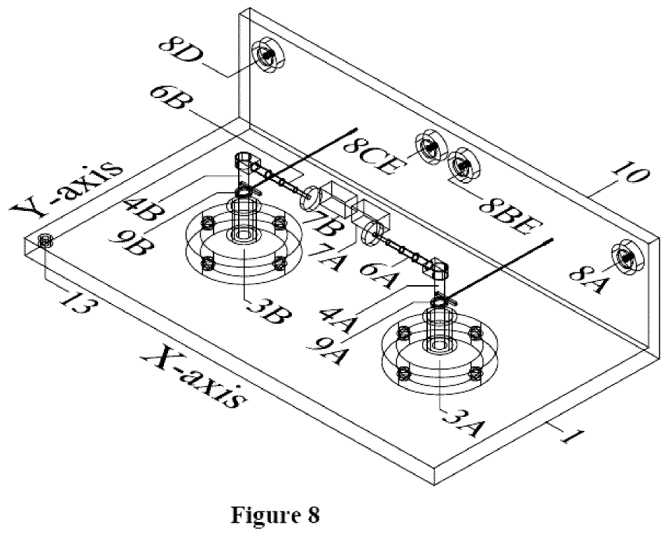

FIG. 8—Immediately after a half-circle journey by the blades 7A and 7B, the electromagnets 6AE and 6BE have turned off. Consequently, the blades 7A and 7B have separated from the adjusters 6A and 6B, respectively. After the separation, the blades 7A and 7B ended the circular motion. We can also say that, after the separation, the blades 7A and 7B ended the angular momentum.

After the circular motion of the blades 7A and 7B have ended; lock structures 9A and 9B lock the shafts 4A and 4B, respectively. As a result, shafts 4A, 4B stop with the adjusters 6A, 6B. Hence, they the shaft 4A, shaft 4B, adjuster 6A and adjuster 6B transfer their momentum to the vehicle.

The momentum of the shafts 4A and 4B just before locking—

Both shafts 4A and 4B have the same mass, angular speed, and the same dimension. So, both shafts 4A and 4B have the same magnitude of angular momentum. Shaft 4A is rotating in the clockwise direction, and shaft 4B is rotating in the anti-clockwise direction.

After locking the shafts 4A and 4B; the momentum transferred from shaft 4A and shaft 4B to the vehicle—

Both shafts 4A and 4B have the same magnitude of angular momentum, but the direction is opposite. So after locking, both shafts 4A and 4B cancel each other's angular momentum. Hence, after locking the shafts 4A and 4B; the momentum transferred from shaft 4A and shaft 4B to the vehicle=0.

After locking the shafts 4A and 4B; the momentum transferred from adjuster 6A and adjuster 6B to the vehicle—

The mass of adjuster 6A and adjuster 6B is near zero. Therefore, there is zero or negligible momentum in the adjuster 6A and adjuster 6B. Hence, after locking the shafts 4A and 4B; the momentum transferred from adjuster 6A and adjuster 6B to the vehicle=zero or insignificant.

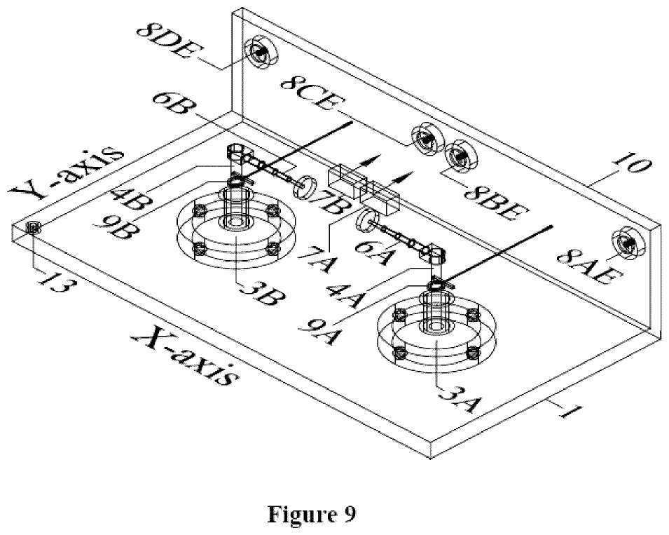

FIG. 9—After the circular motion of the blades 7A and 7B have ended, each blade 7A and 7B is travelling in linear motion with linear velocity +V (Y-axis) and linear momentum +MV (Y-axis). The electromagnets 8BE and 8CE have become operational.

After ending the circular motion, the linear momentum of the blades 7A and 7B=+MV+MV=+2MV (Y-axis) . . . [LM2].

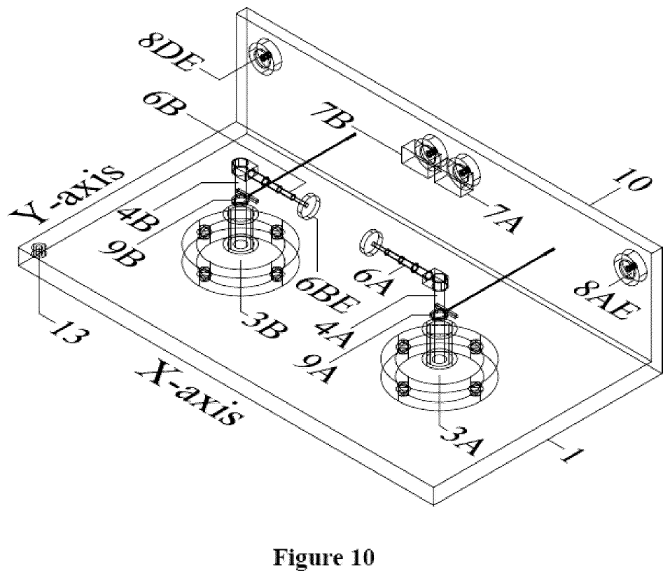

FIG. 10—After travelling, the blades 7A and 7B join with the vehicle via the electromagnets 8BE and 8CE, respectively.

Currently, the linear momentum of the vehicle—

The linear momentum of the vehicle (after the joining of the blades 7A and 7B with the electromagnets 8BE and 8CE=Linear momentum of the vehicle, from [LM1]+Linear momentum of the blades 7A and 7B, from [LM2]+Linear momentum of the vehicle (due to the centripetal reaction force generated by the blades 7A and 7B).

At this stage of the vehicle; each part of the vehicle has the same linear velocity. Right now, the first cycle completed.

Linear momentum of the vehicle (due to the centripetal reaction force generated by the blades 7A and 7B) after completing first cycle—

Definition of the centripetal reaction force—Without a net centripetal force; an object cannot travel in a circular motion. And by Newton's third law centripetal force co-exist with the centripetal reaction force (forces always come in pairs—equal and opposite action-reaction force pairs). If the action force is the centripetal force in a circular motion, then the reaction force of the centripetal force is the centripetal reaction force. In other words, if the action force in circular motion is the centripetal force, then the reaction force is the centripetal reaction force.

In physics, the centripetal reaction force is called reactive centrifugal force. But I am calling reactive centrifugal force a centripetal reaction force. Because I think that calling reactive centrifugal force as centripetal reaction force would make the theory (written here) clear and easily understood. And, I have defined the term centripetal reaction force here.

Understanding the centripetal reaction force—

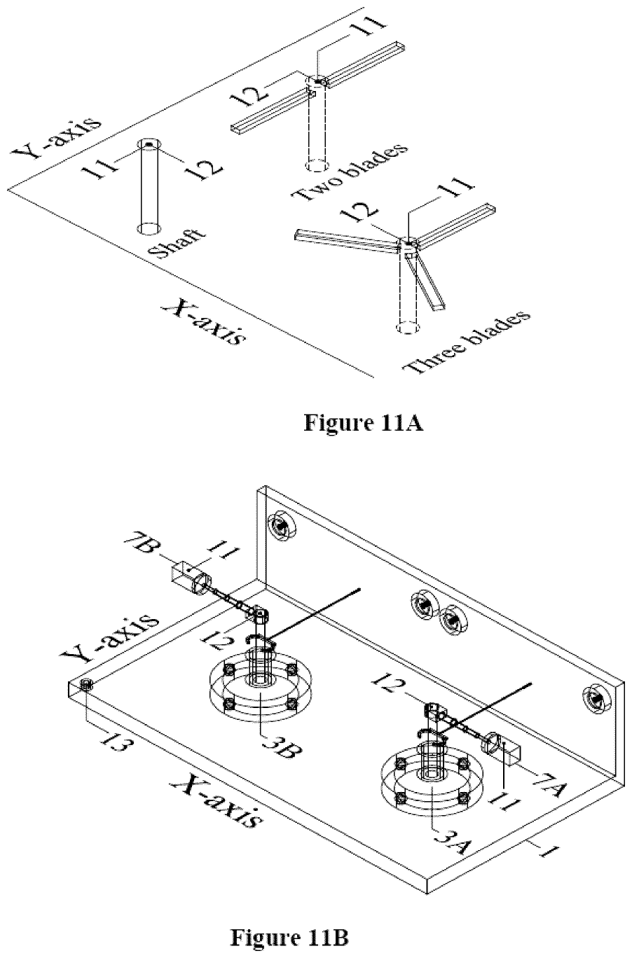

FIG. 11A—As we see in FIG. 11A; the centre of mass 11 of the shaft (of this vehicle or a helicopter) falls on its centre of rotation 12, therefore the net centripetal reaction force of the shaft's circular motion becomes zero.

Again, as we see in FIG. 11A; the centre of mass 11 of two or three blades (of a helicopter) falls on their (two or three blades) centre of rotation 12, therefore the net centripetal reaction force of two or three blades' circular motion becomes zero.

FIG. 11B—This vehicle has only one blade 7A/7B in each circular motion. And as we see in the drawing; the centre of mass 11 of one blade 7A/7B is away from its blade 7A/blade 7B centre of rotation 12, so there will be a centripetal reaction force from one blade's 7A/7B circular motion . . . [P1].

From the above paragraph [P1], we can say that, in operation (half-circle split), each blade's 7A and 7B circular motion generates a centripetal reaction force. And we can also say that, in operation (half-circle split), each blade's 7A and 7B angular momentum generates a centripetal reaction force. In conclusion, we can say that, in this operation (half-circle split)—
Blades 7A and 7B generate (produce) the centripetal reaction force.

The centripetal reaction force generated by each blade 7A and 7B acts on the vehicle. This centripetal reaction force acts as a pulling force (linear force) on the vehicle.

The effect of centripetal reaction force on the vehicle—

Mass of each blade 7A and 7B=M, speed of each blade 7A and 7B=V and radius of each blade 7A and 7B=R.

The blades 7A and 7B are in a uniform circular motion in their half-circle journey. So from the equation of centripetal force, the centripetal force of each blade 7A and 7B=MV2/R.

According to Newton's third law, the centripetal reaction force generated by each blade 7A and 7B will be the same as MV2/R but in the opposite direction.

Now we will decompose the centripetal reaction force into X and Y-axis—

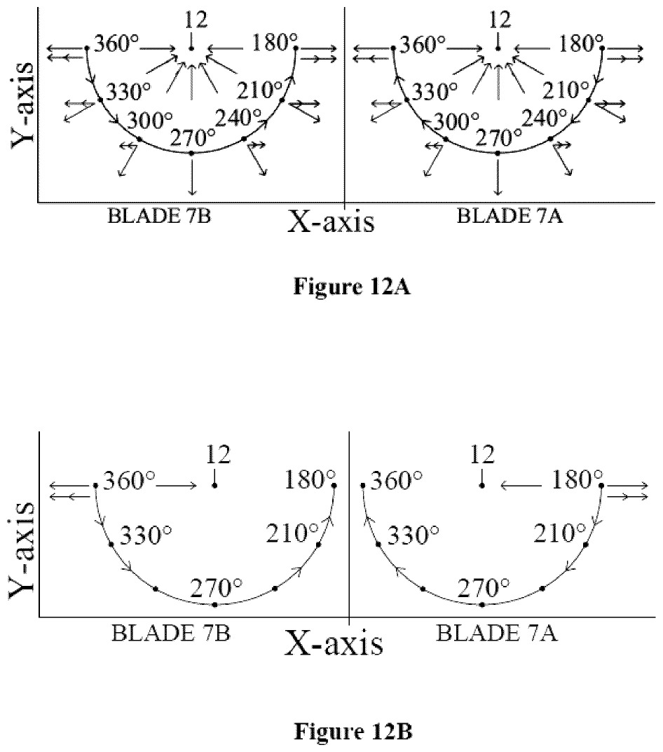

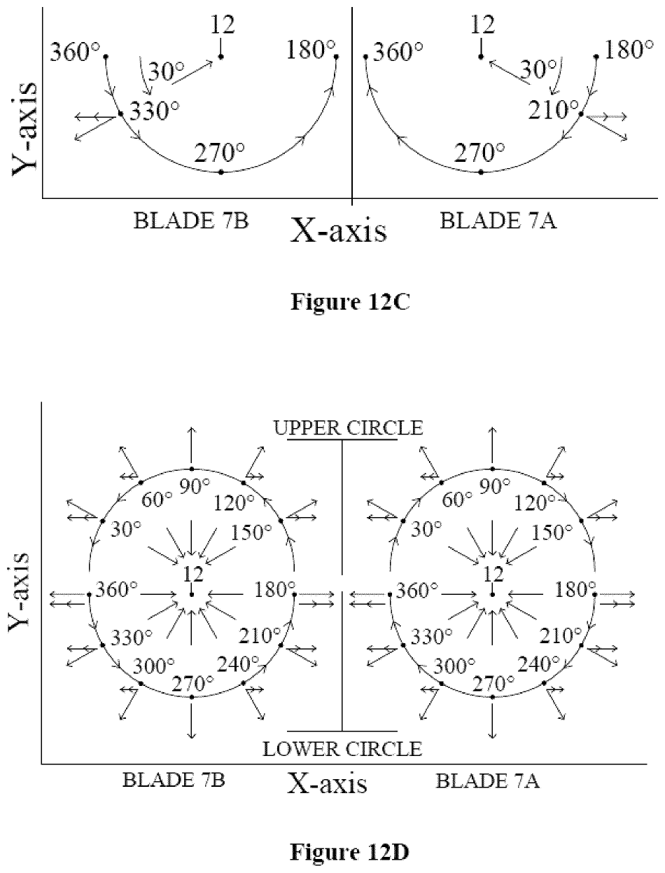

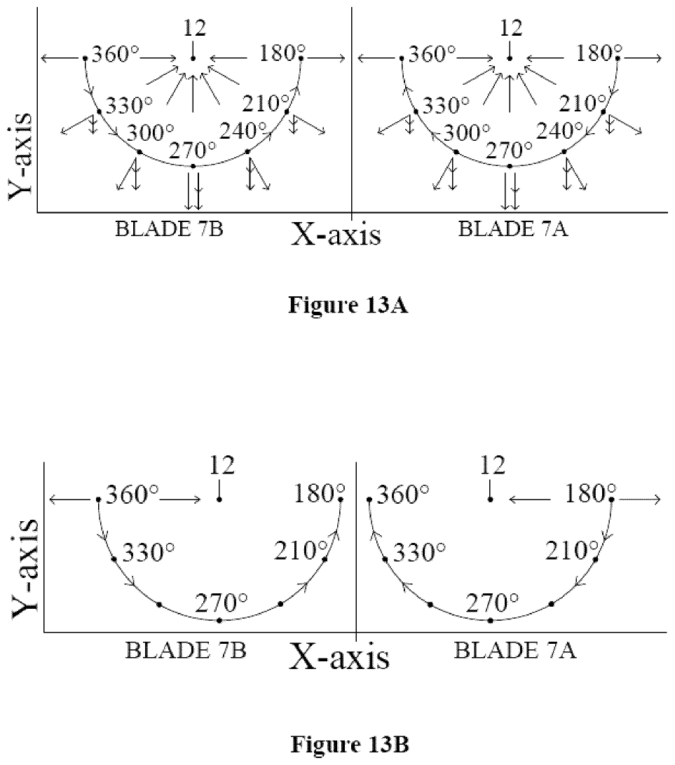

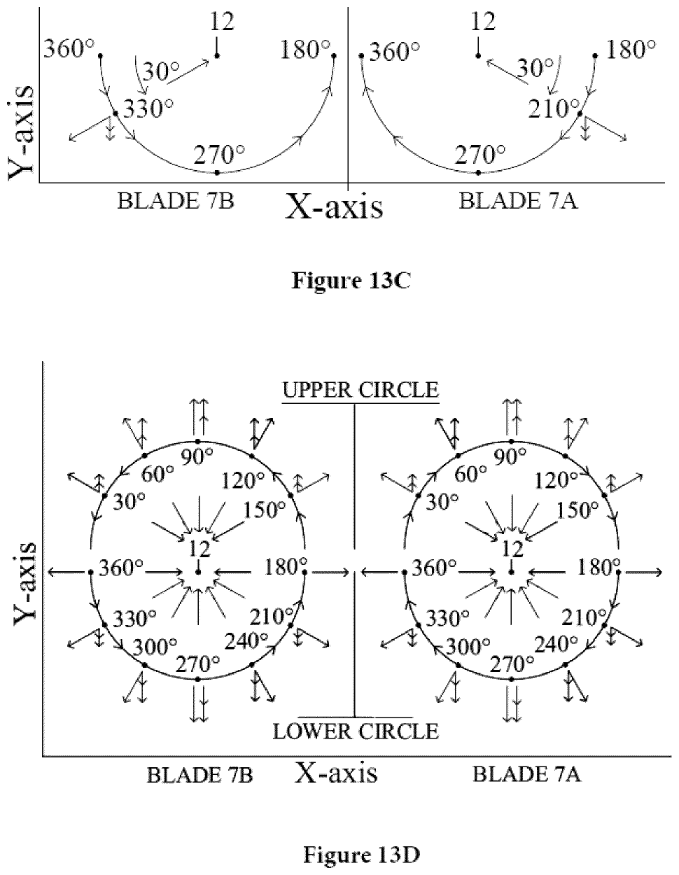

In FIGS. 12A, 12B, 12C, 13A, 13B and 13C, we have drawn the circular path (half-circle travel) of the blades 7A and 7B.

In FIGS. 12A, 12B, 12C, 13A, 13B and 13C, all arrows (one head arrows) directed towards the rotational centre 12 represent the centripetal force acting on the blades 7A and 7B at certain angles.

In FIGS. 12A, 12B, 12C, 13A, 13B and 13C, all arrows (one head arrows) directed away from the rotational centre 12 represent the centripetal reaction force produced by the blades 7A and 7B at certain angles. In other words, all arrows (one head arrows) directed away from the rotational centre 12 represent the centripetal reaction force acting on the vehicle at certain angles.

In FIGS. 12A, 12B and 12C, all arrows (two heads arrows) parallel to the X-axis represent the direction and magnitude of the centripetal reaction force produced by the blades 7A and 7B at certain angles towards the X-axis.

Both blades 7A and 7B have the same speed and a similar radius. So in all timeframes, each blade 7A and 7B will travel to equal angles.

The direction of the centripetal reaction force is derived from the definition of centripetal force and Newton's third law; please refer to the figures for the direction of the centripetal reaction force . . . [P2].

See FIGS. 12A and 12B; at the beginning of circular motion—

At angle 1800, the centripetal reaction force produced by the blade 7A towards X-axis=MV2/R*COS (1800)−MV2/R. After adjusting the direction of the centripetal reaction force from [P2], the centripetal reaction force towards the X-axis=+MV2/R.

At angle 3600, the centripetal reaction force produced by the blade 7B towards X-axis=MV2/R*COS (3600)+MV2/R. After adjusting the direction of the centripetal reaction force from [P2], the centripetal reaction force towards the X-axis=−MV2/R.

Total centripetal reaction force produced by the blades 7A (at angle 1800) and 7B (at angle 3600) towards X-axis=(+MV2/R)+(−MV2/R)=0.

See FIGS. 12A and 12C; after travelling an angle of 300—

At angle 2100, the centripetal reaction force produced by the blade 7A towards X-axis=MV2/R*COS (2100)=−MV2/R*0.866. After adjusting the direction of the centripetal reaction force from [P2], the centripetal reaction force towards the X-axis=+MV2/R*0.866.

At angle 3300, the centripetal reaction force produced by the blade 7B towards X-axis=MV2/R*COS (3300)=+MV2/R*0.866. After adjusting the direction of the centripetal reaction force from [P2], the centripetal reaction force towards the X-axis=−MV2/R*0.866.

Total centripetal reaction force produced by the blades 7A (at angle 2100) and 7B (at angle 3300) towards X-axis=(−MV2/R*0.866)+(+MV2/R*0.866)=0.

With the help of FIGS. 12A, 12B, 12C and calculations above, we see that the centripetal reaction force produced by the blade 7A is getting cancelled instantaneously from the centripetal reaction force produced by the blade 7B towards the X-axis.

In FIGS. 13A, 13B and 13C, all arrows (two heads arrows) parallel to the Y-axis represent the direction and magnitude of the centripetal reaction force produced by the blades 7A and 7B at certain angles towards the Y-axis.

In FIGS. 13A and 13B; at the beginning of circular motion—

At angle 1800, the centripetal reaction force produced by the blade 7A towards Y-axis=MV2/R*SIN (1800)=0.

At angle 3600, the centripetal reaction force produced by the blade 7B towards Y-axis=MV2/R*SIN (3600)=0.

Total centripetal reaction force produced by the blades 7A (at angle 1800) and 7B (at angle 3600) towards Y-axis=0+0=0.

In FIGS. 13A and 13C; after travelling an angle of 300—

At angle 2100, the centripetal reaction force produced by the blade 7A towards Y-axis=MV2/R*SIN (2100)=−MV2/R*0.5. After adjusting the direction of the centripetal reaction force from [P2], the centripetal reaction force towards the Y-axis=−MV2/R*0.5.

At angle 3300, the centripetal reaction force produced by the blade 7B towards Y-axis=MV2/R*SIN (3300)=−MV2/R*0.5. After adjusting the direction of the centripetal reaction force from [P2], the centripetal reaction force towards the Y-axis=−MV2/R*0.5.

Total centripetal reaction force produced by the blades 7A at angle 2100 and 7B at angle 3300 towards Y-axis=(−MV2/R*0.5)+(−MV2/R*0.5)=−2MV2/R*0.5.

With the help of FIGS. 13A, 13B, 13C and calculations above, we see that the centripetal reaction force produced by the blades 7A and 7B acts in the same direction towards the −Y-axis. Hence both the centripetal reaction force (produced by the blades 7A and 7B) is acting on the vehicle towards −Y-axis. In conclusion, we can say that the vehicle generates centripetal reaction force.

The effect of the centripetal reaction force on the vehicle towards Y-axis—

The magnitude of linear momentum (impulse) generated by the centripetal reaction force towards the −Y-axis—

The linear momentum provided to the vehicle by the blade 7A (due to the centripetal reaction force) “between angles 180 to 270 degrees” towards −Y-axis=Impulse=Δt*F.

□ Here Δt is the time taken by the blade 7A to travel “between angles 180 to 270 degrees”. The time taken by the blade 7A to travel “between angles 180 to 270 degrees”=Δt=π2/ω(ω=V/R)=π/2/V/R.

And,

□ F is the average centripetal reaction force generated by the blade 7A “between angles 180 to 270 degrees” towards −Y-axis. The average centripetal reaction force produced by the blade 7A “between angles 180 to 270 degrees” towards −Y-axis=F.

$$F = Centripetal reaction force * ( SIN 1800 + SIN 1810 + ………… + SIN 2690 ) / 90.$$

$$F = MV 2 / R * ( SIN 1800 + SIN 1810 + ………… + SIN 2690 ) / 90.$$

$$F = MV 2 / R * ( 0.6310480562 ) .$$

$$Impulse = Δ t * F = ( π / 2 / V / R ) * ( MV 2 / R * ( 0.6310480562 ) )$$

$$= π / 2 * R / V * MV * V / R * ( 0.6310480562 )$$

$$= 1.571428571 * ( 0.6 3104805 \; 62 ) * MV$$

$$= 0.991646945 * MV ≡ 1 MV .$$

The linear momentum provided to the vehicle by the blade 7A (due to the centripetal reaction force) “between angles 180 to 270 degrees” towards −Y-axis=MV.

Similarly, the linear momentum provided to the vehicle by the blade 7B (due to the centripetal reaction force) “between angles 360 to 270 degrees” towards −Y-axis=MV.

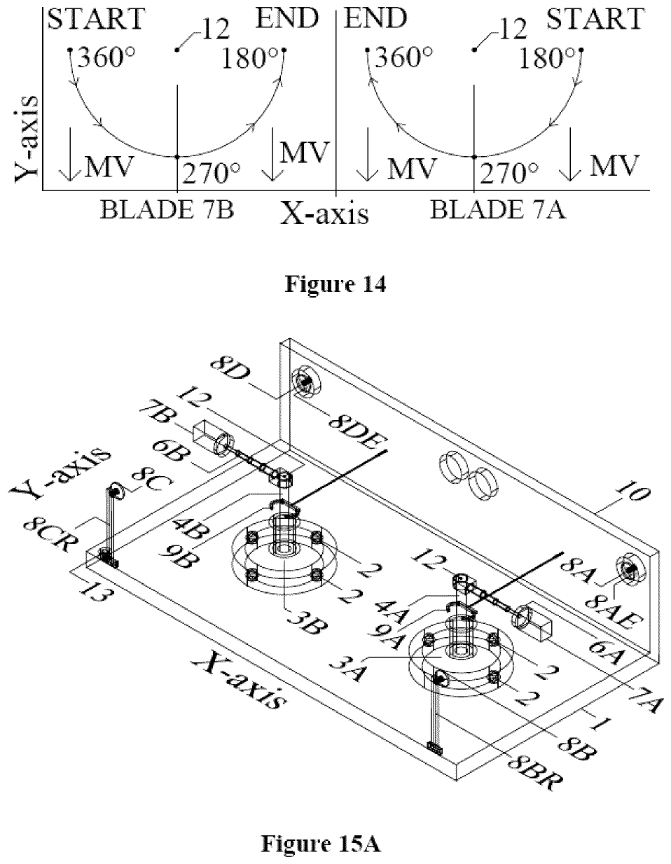

FIG. 14—FIG. 14 shows all the linear momentum provided to the vehicle by the blades 7A and 7B (due to the centripetal reaction force) during the half-circle travel; in the first cycle. Linear momentum provided by the—
Blade 7A between angles 180 to 270 degrees towards Y-axis=−MV.
Blade 7A between angles 270 to 360 degrees towards Y-axis=−MV.
Blade 7B between angles 360 to 270 degrees towards Y-axis=−MV.
Blade 7B between angles 270 to 180 degrees towards Y-axis=−MV.

Total linear momentum provided to the vehicle by the blades 7A and 7B (due to the centripetal reaction force)=4MV (−Y-axis) . . . [LM3].

### Calculation of FIG. 10—

The linear momentum of the vehicle (after the joining of the blades 7A and 7B with the electromagnets 8BE and 8CE=Linear momentum of the vehicle, from [LM1]+Linear momentum of the blades 7A and 7B, from [LM2]+Linear momentum of the vehicle (due to the centripetal reaction force generated by the blades 7A and 7B), from [LM3]=0+2MV+(−4MV)=−2MV (Y-axis) . . . [First cycle, half-circle split].

After completion of all the activities of the first cycle, total net linear momentum provided to the vehicle=−2MV (Y-axis). And, as we've seen above, to get the invented vehicle a linear momentum of 2MV—
A) There is no need to interact with the mass outside the vehicle, and
B) There is no need to throw the mass out of the vehicle.

Interpretation of A)—The vehicle (like car, water ship, aeroplane etc.) that moves on the earth gets linear momentum by giving linear momentum to the mass outside the vehicle.

In other words, such a vehicle receives linear momentum by interacting with the mass outside it. The invented vehicle does not require any interaction with the mass outside it to gain linear momentum.

Interpretation of B)—The vehicle (like space shuttle) that moves on the earth and space gets linear momentum by throwing “the mass” from itself. The mass is not required to be thrown outside by the invented vehicle to gain linear momentum. In other words, there is no need to throw mass out of the invented vehicle to achieve linear momentum.

Therefore as explained herein the centripetal reaction force which is vital to create/generate a net linear momentum for the vehicle in the space without throwing any mass from it (vehicle). Now I am changing the operation process to get a good understanding of the centripetal reaction force. The vehicle is modified slightly to change the operation process.

### Description Modified Vehicle

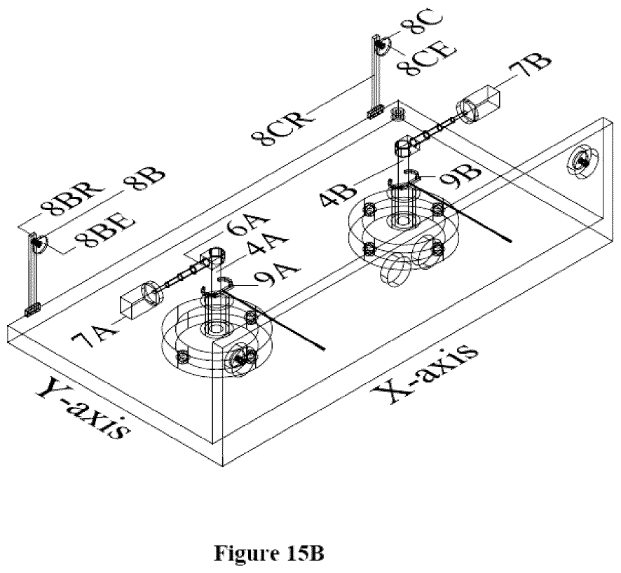

FIGS. 15A and 15B—This modified invented vehicle is similar to the invented vehicle discussed earlier in FIG. 1A. The only difference of this modified invented vehicle is that thrust structures 8B and 8C have been shifted in front of thrust structures 8A and 8D, respectively.

The drawing of the modified invented vehicle is illustrated in FIG. 15A (3D SE isometric wireframe view) and 15B (3D NE isometric wireframe view). To shift the thrust structures 8B and 8C, rigid bodies 8BR and 8CR were added. The shifted thrust structures 8B and 8C have been fixed in the (added) rigid bodies 8BR and 8CR, respectively. The (added) rigid bodies 8BR and 8CR have been fixed in the rigid base1.

### Operation—FIGS. 12D, 13D, 15A and 16-21—Slightly Modified Embodiment (Full-Circle Split)

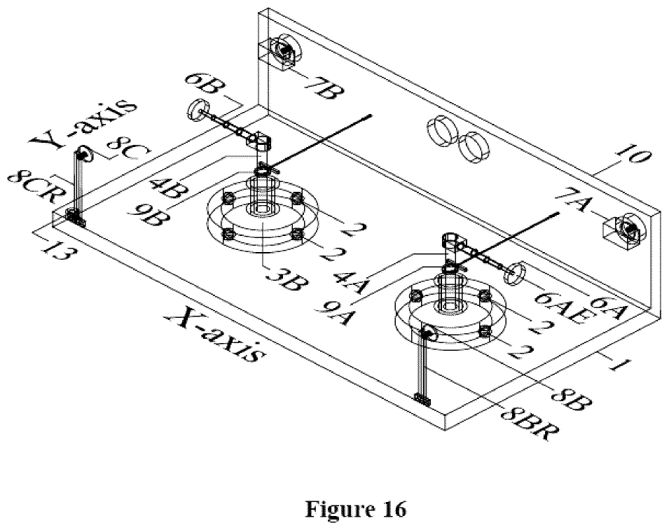

FIG. 16—In the beginning, blades 7A and 7B, adjusters 6A and 6B, rigid base 1, rigid body 10, rigid bodies 8BR and 8CR, thrust structures 8A, 8B, 8C, and 8D and X-axis are parallel. The blades 7A and 7B are near the thrust structures 8A and 8D, respectively. The electromagnets 8AE, 8BE, 8CE and 8DE are off. Shafts 4A and 4B have been locked by the lock structures 9A and 9B, respectively.

The power source 13 turns on. The first cycle of this operation (full-circle split) begins.

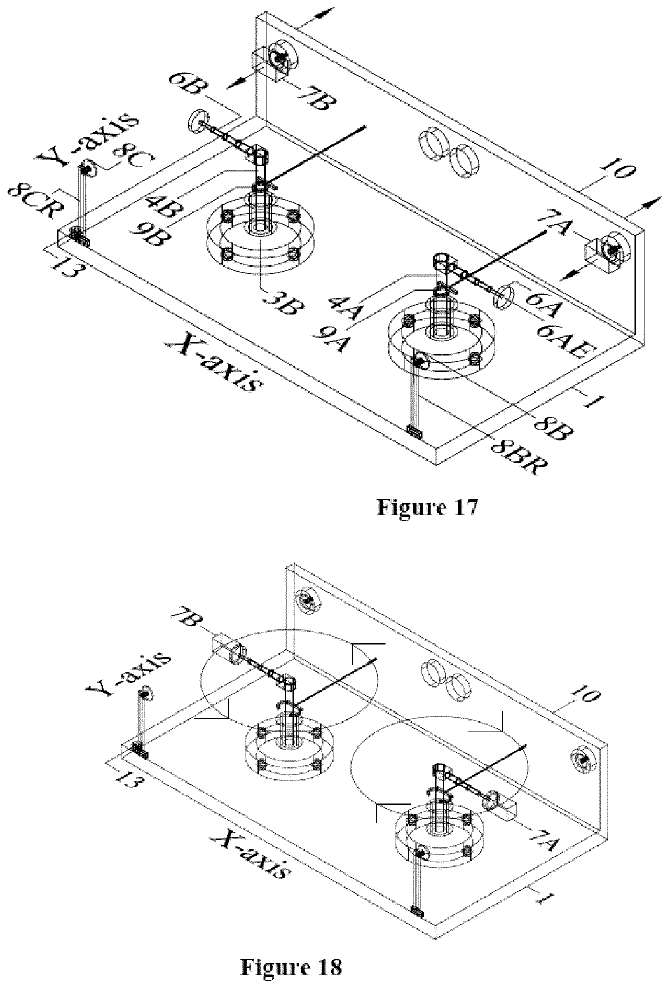

FIG. 17—The blades 7A and 7B are pushed by the thrust structures 8A and 8D, respectively, towards −Y-axis. As a result, each blade 7A and 7B starts the linear motion with linear velocity V (−Y-axis) and linear momentum MV (−Y-axis). By the law of conservation of momentum, the vehicle gets linear momentum of 2MV (+Y-axis).

After getting the linear motion, the blades 7A and 7B are travelling. Each blade 7A and 7B is travelling with linear velocity −V (Y-axis). The electromagnets 6AE and 6BE have become operational.

FIG. 15A—The lock structures 9A and 9B have unlocked the shafts 4A and 4B, respectively. After travelling, the blades 7A and 7B stick with the electromagnets 6AE and 6BE, respectively. Now the blade 7A and adjuster 6A joined via electromagnet 6AE, and the blade 7B and adjuster 6B joined via electromagnet 6BE. Each blade 7A and 7B joined at a distance R from the centre of rotation 12.

Currently, the total linear momentum of the vehicle (after the joining of the blades 7A and 7B with the adjusters 6A and 6B)=Linear momentum of the vehicle+Linear momentum of the blades 7A and 7B=+2MV−MV−MV=0 . . . [LM1].

After joining, the blades 7A and 7B start the circular motion. The circular motion/angular momentum of the blades 7A and 7B generate centripetal reaction force. And, from the law of conservation of angular momentum—
Angular momentum of the blade 7A=MVR (in a clockwise direction).
Angular momentum of the blade 7B=MVR (in an anti-clockwise direction).

FIG. 18—Each blade 7A and 7B stays on circular motion with speed V, let the blades 7A and 7B travel the full-circle.

After some time, the blades 7A and 7B have travelled the full-circle. Here, the blades' 7A and 7B instantaneous velocity is the same as the “start”=−V (Y-axis).

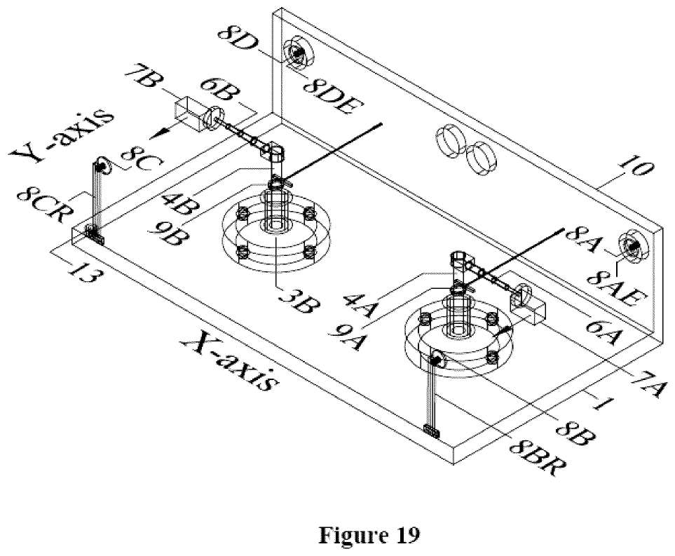

FIG. 19—Immediately after a full-circle journey by the blades 7A and 7B, the electromagnets 6AE and 6BE have turned off. Consequently, the blades 7A and 7B have separated from the adjusters 6A and 6B, respectively. After the separation, the blades 7A and 7B ended the circular motion.

After the circular motion of the blades 7A and 7B have ended; lock structures 9A and 9B lock the shafts 4A and 4B, respectively. As a result, shafts 4A, 4B stop with the adjusters 6A, 6B. Hence, they the shaft 4A, shaft 4B, adjuster 6A and adjuster 6B transfer their momentum to the vehicle.

After locking the shafts 4A and 4B; the momentum transferred from shaft 4A, shaft 4B, adjuster 6A and adjuster 6B to the vehicle=0. (See the description of FIG. 8, half-circle split).

After the circular motion of the blades 7A and 7B have ended, each blade 7A and 7B is travelling in linear motion with linear velocity −V (Y-axis) and linear momentum −MV (Y-axis).

After ending the circular motion, the linear momentum of the blades 7A and 7B=−MV−MV=−2MV (Y-axis) . . . [LM2 different].

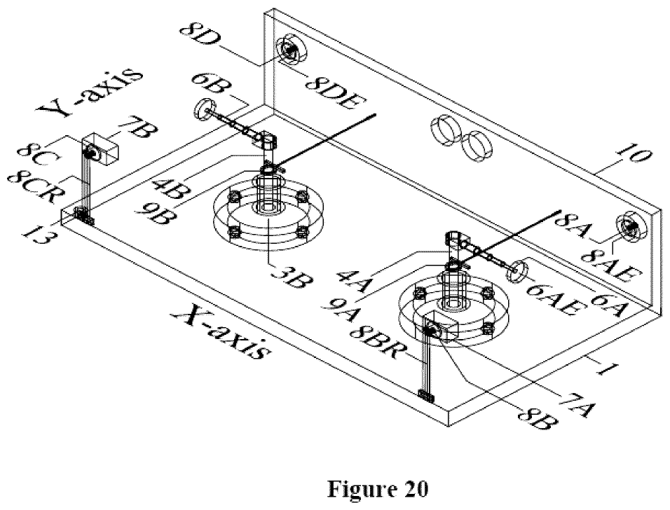

FIG. 20—The electromagnets 8BE and 8CE have become operational. After travelling, the blades 7A and 7B join with the vehicle via the electromagnets 8BE and 8CE, respectively.

At this stage of the vehicle; each part of the vehicle has the same linear velocity. Right now, the first cycle completed.

### Currently, the Linear Momentum of the Vehicle—

The linear momentum of the vehicle (after the joining of the blades (7A and 7B) with the electromagnets (8BE and 8CE))=Linear momentum of the vehicle, from [LM1]+Linear momentum of the blades 7A and 7B, from [LM2 different]+Linear momentum of the vehicle (due to the centripetal reaction force generated by the blades 7A and 7B).

Linear momentum of the vehicle (due to the centripetal reaction force generated by the blades 7A and 7B)—

From FIG. 11B and its description; even in this operation, the blades 7A and 7B generate (produce) the centripetal reaction force.

The total centripetal reaction force given to the vehicle by the blades 7A and 7B in the full-circle travel towards the X and Y-axis=0. Therefore, the net linear momentum given to the vehicle due to the centripetal reaction force of the blades 7A and 7B=0 . . . [LM3 different].

By the calculations, we found that in a full-circle journey, the blades 7A and 7B give zero centripetal reaction force (in total) to the vehicle towards the X and Y-axis. But I have not given lengthy calculations here as the two simple figures (12D and 13D) can make sense of it.

In FIGS. 12D and 13D, we have drawn the circular path (full-circle travel) of the blades (7A and 7B) and three types of arrows. The circular path of the blades 7A and 7B is drawn separately into two equal parts. One part is shown (represented) as the lower circle and the other part as the upper circle. The arrows in FIG. 12D represent the same things previously depicted in FIG. 12A. In other words, the arrows in FIG. 12D represent the same things said earlier for FIG. 12A. Similarly, the arrows in FIG. 13D represent the same things previously depicted in FIG. 13A.

FIG. 12D—earlier, we had calculated the effect of the centripetal reaction force of the lower circle (see FIGS. 12A, 12B, and 12C) on the vehicle towards the X-axis. The effect of the upper circle is the same as that of the lower circle towards the X-axis on the vehicle (look at the direction of the arrows representing the centripetal reaction force towards the X-axis). So the net centripetal reaction force acting on the vehicle is zero towards the X-axis.

FIG. 13D—earlier, we had calculated the effect of the centripetal reaction force of the lower circle (see FIGS. 13A, 13B, and 13C) on the vehicle towards the Y-axis. The effect of the upper circle on the vehicle towards the Y-axis is exactly opposite to that of the lower circle (look at the direction of the arrows representing the centripetal reaction force towards the Y-axis). So in the full-circle journey of the blades 7A and 7B, the net centripetal reaction force becomes zero for the vehicle towards the Y-axis.

In this operation, we saw that the vehicle receives zero centripetal reaction force (in total), although the blades 7A and 7B generate centripetal reaction force. At the full-circle journey of the blades 7A and 7B, the vehicle gets zero centripetal reaction force in total.

### Calculation of FIG. 20—

The linear momentum of the vehicle (after the joining of the blades (7A and 7B) with the electromagnets (8BE and 8CE))=0 [LM1]+(−2MV) [LM2 different]+0 [LM3 different]=−2MV (Y-axis) . . . [First cycle, full-circle split].

After the completion of all the activities of the first cycle, total net linear momentum provided to the vehicle=−2MV (Y-axis).

Now the second cycle of operation “full-circle split” is starting; in the second cycle of the operation (full-circle split), we will arrange all the parts of the vehicle, so that the positions of all the parts of the vehicle are in the “beginning position” with respect to one another.

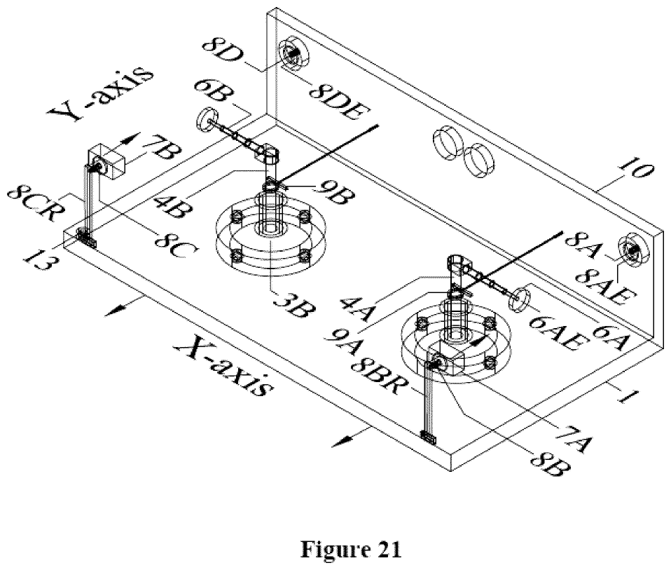

FIG. 21—In the second cycle, the electromagnets 8BE and 8CE have turned off. The blades 7A and 7B are pushed by the thrust structures 8B and 8C, respectively, towards +Y-axis. As a result, each blade 7A and 7B starts the linear motion with linear velocity V (+Y-axis) and linear momentum MV (+Y-axis). By the law of conservation of momentum, the vehicle gets linear momentum of 2MV (−Y-axis).

After getting the linear motion, the blades 7A and 7B are travelling. Each blade 7A and 7B is travelling with linear velocity +V (Y-axis). Remember that the electromagnets 6AE and 6BE are off. The electromagnets 8AE and 8DE have become operational.

Currently, the linear momentum of the vehicle=(−2MV, Y-axis), from [first cycle, full-circle split]+(−2MV, Y-axis) . . . [LM1 second cycle, full-circle split].

Linear momentum of the blades 7A and 7B=+MV+MV=(+2MV, Y-axis) . . . [LM2 second cycle, full-circle split].

FIG. 16—After travelling, the blades 7A and 7B join with the vehicle via the electromagnets 8AE and 8DE, respectively.

Linear momentum of the vehicle (final)=Linear momentum of the vehicle, from [LM1 second cycle, full-circle split]+Linear momentum of the blades 7A and 7B, from [LM2 second cycle, full-circle split].

Linear momentum of the vehicle (final)=(−2MV, Y-axis)+(−2MV, Y-axis)+(2MV, Y-axis)=(−2MV, Y-axis).

At this stage of the vehicle; each part of the vehicle has the same linear velocity. Right now, the second cycle completed.

After completion of the second cycle; the positions of all parts of the vehicle in relation to one another are in the “beginning position” (same as the beginning of the first cycle).

After completion of all the activities mentioned above of operation “full-circle split”, the invented vehicle gets a linear momentum of 2MV—
Without interacting with the mass outside the vehicle, and
Without throwing the mass from itself (the vehicle).

In this operation (full-circle split), we saw that the vehicle receives zero centripetal reaction force in total, although the vehicle generates centripetal reaction force.

At the blades' 7A and 7B first full-circle journey, the vehicle receives a total of zero centripetal reaction force. If the blades' 7A and 7B circular motion continues after a full-circle journey, the vehicle again starts gaining the centripetal reaction force. At the blades' 7A and 7B second full-circle journey, the vehicle again receives a total of zero centripetal reaction force. At every full-circle journey of the blades 7A and 7B, the vehicle receives a total of zero centripetal reaction force, although the vehicle generates centripetal reaction force.

In this operation (full-circle split), the vehicle receives a total of zero linear momentum from the blades 7A and 7B (due to the centripetal reaction force). The vehicle gets net linear momentum directly from the blades' 7A and 7B angular momentum when blades 7A and 7B end the circular motion and come in a linear motion and join the vehicle.

As we have seen in the events of FIGS. 4, 1A and 5, the blades 7A and 7B were with linear momentum, but when we provided the axis of rotation for them (blades 7A and 7B), the blades 7A and 7B also received angular momentum.

To understand, we can say that the angular momentum of the blades 7A and 7B was hidden in their linear momentum. To get the angular momentum from the linear momentum of the blades 7A and 7B, we had fulfilled a condition, that is—
1) We provided the axis of rotation for the blades 7A and 7B.

Similarly, to get the net linear momentum from the angular momentum of the blades 7A and 7B, we had fulfilled two conditions, they are—
1) Generating centripetal reaction force from the circular motion/angular momentum of the blade 7A. Similarly, generating centripetal reaction force from the circular motion/angular momentum of the blade 7B.
2) Ending the circular motion/angular momentum of the blades 7A and 7B completely or partially. As we have seen in the above operations, the circular motion/angular momentum of the blades 7A and 7B ends completely.

We can end the circular motion/angular momentum of the blades 7A and 7B partially in place of ending it entirely. We can end the blades' 7A and 7B circular motion/angular momentum partially in several ways, for example—20
By reducing the speed of blades' 7A and 7B circular motion. Or,
Suppose the blades 7A and 7B are in two-part and only one part of the blades 7A and 7B separated from the circular motion.

So, ending the blades' 7A and 7B circular motion/angular momentum means—ending the blades' 7A and 7B circular motion/angular momentum entirely or partially.

In operation “full-circle split”, we got the linear momentum directly from the blades' 7A and 7B angular momentum. But in operation “half-circle split”, we got the linear momentum through the blades' 7A and 7B centripetal reaction force. The centripetal reaction force is an effect (outcome) of the angular momentum/circular motion.

After fulfilling the two conditions mentioned above—

We arranged the position of blades 7A and 7B in the beginning position in such a way that the linear momentum transferred by blades 7A and 7B (of the previous cycle) to the vehicle maintained. For example, in operation “full-circle split”, we sent the blades 7A and 7B directly from thrust structures 8B and 8C to thrust structures 8A and 8D. We did not provide the rotational axis for the blades 7A and 7B in the second cycle.

Now the second cycle of operation “half-circle split” is starting; in the second cycle of the operation (half-circle split), we will arrange all the parts of the vehicle, so that the positions of all the parts of the vehicle are in the “beginning position” with respect to one another.

Operation—FIGS. 1A, 2, 6, 10, 12A, 12B, 12C, 13A, 13B, 13C, 22 and 23—Preferred Embodiment (half-circle split, second cycle)

FIG. 10—blades 7A and 7B, adjusters 6A and 6B, rigid base 1, rigid body 10, thrust structures 8A, 8B, 8C, and 8D and X-axis are parallel.

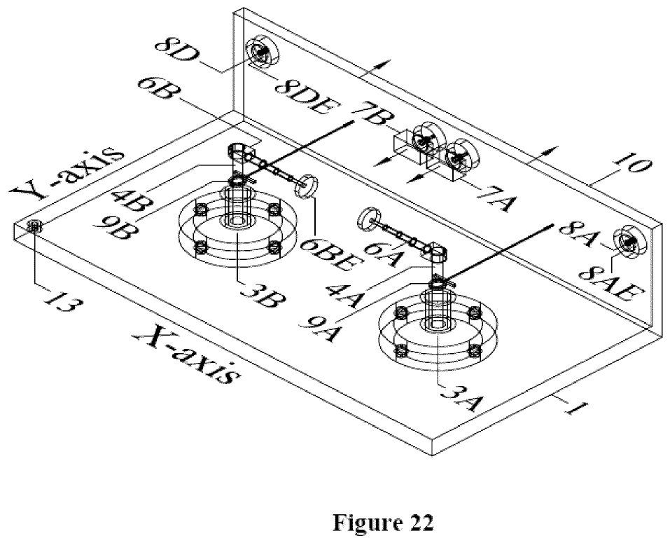

FIG. 22—In the second cycle, the electromagnets 8BE and 8CE have turned off. The blades 7A and 7B are pushed by the thrust structures 8B and 8C, respectively, towards −Y-axis. As a result, each blade 7A and 7B starts the linear motion with linear velocity V (−Y-axis) and linear momentum MV (−Y-axis). By the law of conservation of momentum, the vehicle gets linear momentum of 2MV (+Y-axis).

After getting the linear motion, the blades 7A and 7B are travelling. Each blade 7A and 7B is travelling with linear velocity −V (Y-axis).

Currently, the total linear momentum of the vehicle=−2MV (Y-axis), from [first cycle, half-circle split]+2MV (Y-axis) . . . [FIG. 22].

FIG. 6—The lock structures 9A and 9B have unlocked the shafts 4A and 4B, respectively. The electromagnets 6AE and 6BE have become operational.

After travelling, the blades 7A and 7B stick with the electromagnets 6AE and 6BE, respectively. Now the blade 7A and adjuster 6A joined via electromagnet 6AE, and the blade 7B and adjuster 6B joined via electromagnet 6BE. Each blade 7A and 7B joined at a distance R from the centre of rotation 12.

Currently, the total linear momentum of the vehicle (after the joining of the blades (7A and 7B) with the adjusters (6A and 6B))=Linear momentum of the vehicle, from [FIG. 22]+Linear momentum of the blades 7A and 7B=−2MV+2MV−MV−MV=−2MV, (Y-axis) . . . [LM1 second cycle, half-circle split].

After joining, the blades 7A and 7B start the circular motion. The circular motion/angular momentum of the blades 7A and 7B generate centripetal reaction force. And, from the law of conservation of angular momentum—
Angular momentum of the blade 7A=MVR (in an anti-clockwise direction).
Angular momentum of the blade 7B=MVR (in a clockwise direction).

Each blade 7A and 7B stays on circular motion with speed V.

FIG. 1A—Blades 7A and 7B have travelled the half-circle. Here, the blades' (7A and 7B) instantaneous velocity becomes the opposite of the start=+V (Y-axis).

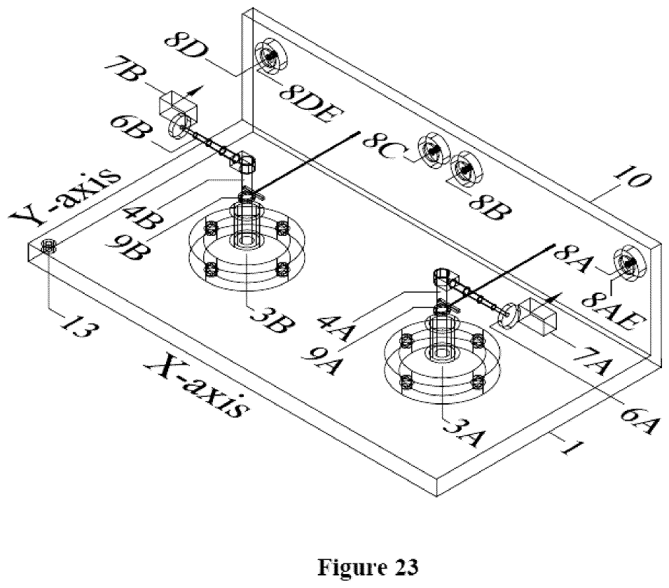

FIG. 23—Immediately after a half-circle journey by the blades 7A and 7B, the electromagnets 6AE and 6BE have turned off. Consequently, the blades 7A and 7B have separated from the adjusters 6A and 6B, respectively. After the separation, the blades 7A and 7B ended the circular motion.

After the circular motion of the blades 7A and 7B have ended; lock structures 9A and 9B lock the shafts 4A and 4B, respectively. As a result, shafts 4A, 4B stop with the adjusters 6A, 6B. Hence, they the shaft 4A, shaft 4B, adjuster 6A and adjuster 6B transfer their momentum to the vehicle.

After locking the shafts 4A and 4B; the momentum transferred from shaft 4A, shaft 4B, adjuster 6A and adjuster 6B to the vehicle=0. (See description of FIG. 8, half-circle split).

After the circular motion of the blades 7A and 7B have ended, each blade 7A and 7B is travelling in linear motion with linear velocity +V (Y-axis) and linear momentum+MV (Y-axis).

After ending the circular motion, the linear momentum of the blades 7A and 7B=+MV+MV=+2MV (Y-axis) . . . [LM2 second cycle, half-circle split].

FIG. 2—The electromagnets 8AE and 8DE have become operational. After travelling, the blades 7A and 7B join with the vehicle via the electromagnets 8AE and 8DE, respectively.

The linear momentum of the vehicle (after the joining of the blades 7A and 7B with the electromagnets 8AE and 8DE)=Linear momentum of the vehicle, from [LM1 second cycle, half-circle split]+Linear momentum of the blades 7A and 7B, from [LM2 second cycle, half-circle split]+Linear momentum of the vehicle (due to the centripetal reaction force generated by the blades 7A and 7B).

Linear momentum of the vehicle (due to the centripetal reaction force generated by the blades 7A and 7B)—

At this stage of the vehicle; each part of the vehicle has the same linear velocity. Right now, the second cycle completed.

In the first cycle of this operation (half-circle split)—[1C]
a) The blade 7A was in the clockwise circular motion from angle 1800 to angle 3600.
b) The blade 7B was in the anti-clockwise circular motion from angle 3600 to angle 1800.

In the second cycle of this operation (half-circle split)—[2C]
a) The blade 7B was in the clockwise circular motion from angle 1800 to angle 3600.
b) The blade 7A was in the anti-clockwise circular motion from angle 3600 to angle 1800.

From FIGS. 12A, 12B, 12C, 13A, 13B and 13C and their descriptions, and, by comparing 1C and 2C; we can see that the centripetal reaction force (produced by the blades 7A and 7B) will give the same effect on the vehicle in the first and second cycle. Therefore, without going into the calculation again, we can get the following for the second cycle—
Towards X-axis, no net centripetal reaction force works on the vehicle.
Towards Y-axis, net centripetal reaction force works on the vehicle. And, total linear momentum provided to the vehicle by the blades 7A and 7B (due to the centripetal reaction force)=4MV (−Y-axis) . . . [LM3 second cycle, half-circle split].

### Calculation of FIG. 2—

The linear momentum of the vehicle (after the joining of the blades (7A and 7B) with the electromagnets (8AE and 8DE))=Linear momentum of the vehicle, from [LM1 second cycle, half-circle split]+Linear momentum of the blades 7A and 7B, from [LM2 second cycle, half-circle split]+Linear momentum of the vehicle (due to the centripetal reaction force generated by the blades 7A and 7B), from [LM3 second cycle, half-circle split]-2MV+2MV+(−4MV)=−4MV (Y-axis).

As we've seen above, after completion of the second cycle, the invented vehicle gets an additional linear momentum of 2MV—
Without interacting with the mass outside the vehicle, and
Without throwing the mass from itself (the vehicle).

After the completion of the second cycle; the positions of all parts of the vehicle in relation to one another are in the “beginning position” (same as the beginning of the first cycle).

### Operation—FIGS. 1A, 5, 6 and 7—Preferred Embodiment (Modified Start)

FIGS. 1A and 5—In the beginning, blades 7A and 7B, adjusters 6A and 6B, rigid base 1, rigid body 10, thrust structures 8A, 8B, 8C, and 8D and X-axis are parallel. The electromagnets 6AE and 6BE are on. The adjuster 6A and blade 7A are connected via the electromagnet 6AE. The adjuster 6B and blade 7B are connected via the electromagnet 6BE.

The power source 13 turns on. The first cycle of this operation (modified start) begins.

The motors 3A and 3B start in the clockwise and anti-clockwise direction, respectively. As a result, each blade 7A and 7B gets angular speed ω(ω=V/R) in the clockwise and anti-clockwise direction, respectively. Here V is the speed of each blade 7A and 7B, and R the radius of each blade 7A and 7B.

In this operation, we see that the blades 7A and 7B start the circular motion directly from the motors 3A and 3B. And from the beginning, the blades 7A and 7B are connected to adjusters 6A and 6B, respectively.

From the equation of angular momentum, each blade 7A and 7B has an angular momentum of MVR in the clockwise and anti-clockwise direction, respectively. By the law of conservation of angular momentum, each motor 3A and 3B gets an angular momentum of MVR in the anti-clockwise and clockwise direction, respectively. Remember that, the motors 3A and 3B are free to rotate.

The blades 7A and 7B instantly achieve the angular momentum. And, after achieving the angular momentum by the blades 7A and 7B, motors 3A and 3B switched off. The circular motion/angular momentum of the blades 7A and 7B generate centripetal reaction force.

Each blade 7A and 7B stays on circular motion with speed V.

FIGS. 6 and 7—Blades 7A and 7B have travelled the half-circle till angle 3600 and angle 1800, respectively. Here the motors 3A and 3B stop the shafts 4A and 4B, respectively. FIG. 7 shows the path of blades' 7A and 7B half-circle travel with some angles.

After stopping the shafts 4A and 4B; the circular motion of the blades 7A and 7B ends.

Now, the motors 3A, 3B and blades 7A, 7B are at rest, and, the motors 3A, 3B and blades 7A, 7B have zero angular momentum. Right now, the first cycle completed.

After the completion of the first cycle—
Angular momentum of the motors 3A and 3B and blades 7A, 7B=0.
Total linear momentum provided to the vehicle by the blades 7A and 7B (due to the centripetal reaction force)—

From FIG. 11B and its description; the blades 7A and 7B generate (produce) the centripetal reaction force. And, from [LM3]—

Total linear momentum provided to the vehicle by the blades 7A and 7B (due to the centripetal reaction force)=4MV (−Y-axis).

After completion of all the activities of the first cycle, total net linear momentum provided to the vehicle=total linear momentum provided to the vehicle by the blades 7A and 7B (due to the centripetal reaction force)=4MV (−Y-axis).

In this operation (modified start), we see that only the centripetal reaction force (generated by the blades 7A and 7B) generates the linear momentum for the vehicle. In other operations, the blades 7A and 7B generate the linear momentum from the centripetal reaction force, and—
When the blades 7A and 7B end the circular motion and come in a linear motion.

After completion of all the activities mentioned above of operation “modified start”, the invented vehicle gets linear momentum of 4MV—
Without interacting with the mass outside the vehicle, and, without throwing the mass from itself (the vehicle).

Now the second cycle of this operation (modified start) is starting; in the second cycle of the operation (modified start), we will arrange all the parts of the vehicle, so that the positions of all the parts of the vehicle are in the “beginning position” with respect to one another.

Like the previous operation (half-circle split), the second cycle of this operation (modified start) starts from the vehicle's current state. In the second cycle, the motors 3A and 3B start in the anti-clockwise and clockwise direction, respectively. Accordingly, the blades 7A and 7B start in the anti-clockwise and clockwise circular motion, respectively.

Subsequently, the second cycle process will be the same as it was in the first cycle of this operation (modified start).

After the completion of the second cycle, the invented vehicle gets an additional linear momentum of 4MV, and, the positions of all parts of the vehicle in relation to one another are in the “beginning position” (same as the beginning of the first cycle).

### Operation—FIGS. 1A, 2, 3, 4, 6, 7, 8, 9, 10, 12A, 12B, 12C, 13A, 13B, 13C, 24, 25, 26 and 27—Preferred Embodiment (Variable Radius)

FIG. 2—In the beginning, blades 7A and 7B, adjusters 6A and 6B, rigid base 1, rigid body 10, thrust structures 8A, 8B, 8C, and 8D and X-axis are parallel. The blades 7A and 7B are near the thrust structures 8A and 8D, respectively. The electromagnets 8AE, 8BE, 8CE and 8DE are off (not operational). Shafts 4A and 4B have been locked (fix in place) by the lock structures 9A and 9B, respectively.

The power source 13 turns on. The first cycle of this operation (variable radius) begins.

FIG. 3—The blades 7A and 7B are pushed by the thrust structures 8A and 8D, respectively, towards −Y-axis. As a result, each blade 7A and 7B starts the linear motion with linear velocity V (−Y-axis) and linear momentum MV (−Y-axis). By the law of conservation of momentum, the vehicle gets linear momentum of 2MV (+Y-axis).

FIG. 4—after getting the linear motion, the blades 7A and 7B are travelling. Each blade 7A and 7B is travelling with linear velocity −V (Y-axis). The electromagnets 6AE and 6BE have become operational. Electromagnets 6AE and 6BE are ready to catch the blades 7A and 7B, respectively. The lock structures 9A and 9B have unlocked the shafts 4A and 4B, respectively.

FIG. 1A—after travelling, the blades 7A and 7B stick with the electromagnets 6AE and 6BE, respectively. Now the blade 7A and adjuster 6A joined via electromagnet 6AE, and the blade 7B and adjuster 6B joined via electromagnet 6BE. Each blade 7A and 7B joined at a distance R from the centre of rotation 12.

By the law of conservation of linear momentum—

Currently, the total linear momentum of the vehicle (after the joining of the blades 7A and 7B with the adjusters 6A and 6B)=Linear momentum of the vehicle+Linear momentum of the blades 7A and 7B=+2MV−MV−MV=0 . . . [LM1].

After joining, the blades 7A and 7B start the circular motion. The circular motion/angular momentum of the blades 7A and 7B generates centripetal reaction force. And, from the law of conservation of angular momentum—
Angular momentum of the blade 7A=MVR (in a clockwise direction).
Angular momentum of the blade 7B=MVR (in an anti-clockwise direction).

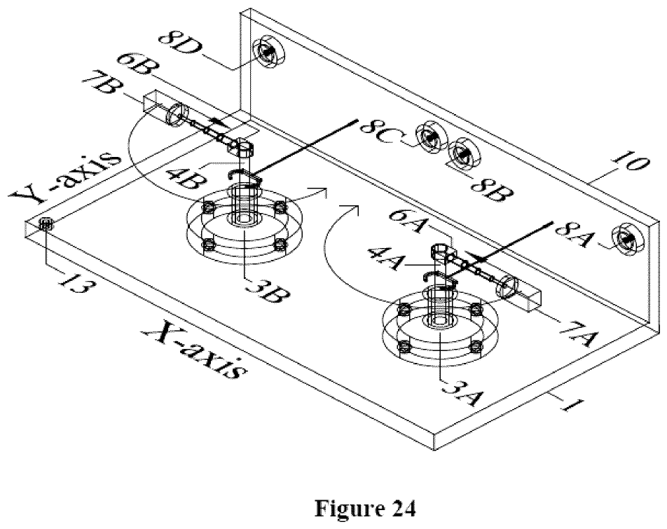

FIG. 24—Immediately after starting the circular motion by the blades 7A and 7B. In other words, immediately after achieving the angular momentum by the blades 7A and 7B—
The adjuster 6A starts pulling blade 7A towards the shaft 4A. And,
The adjuster 6B starts pulling blade 7B towards the shaft 4B.

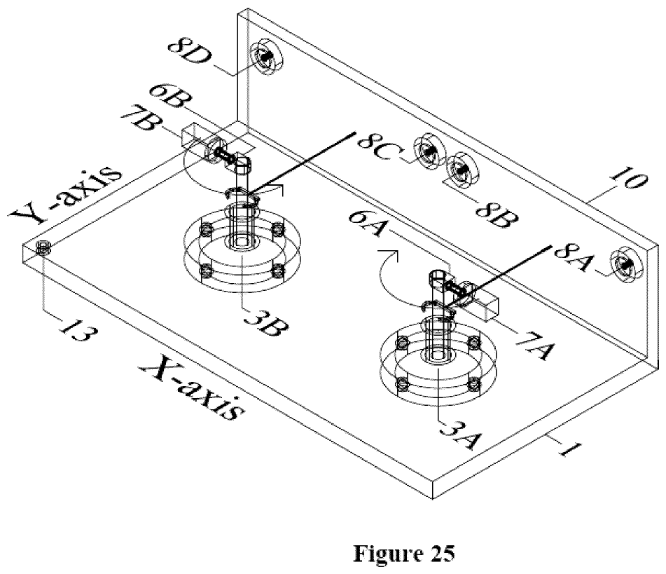

FIG. 25—In a flash, adjusters 6A and 6B pulled the blades 7A and 7B, respectively. After pulling the blades 7A and 7B, the radius of the blades 7A and 7B decreased. The radius of each blade 7A and 7B becomes R/2 from R. Each blade 7A and 7B stays on circular motion.

The angular momentum of the blades 7A and 7B, after being radius R to radius R/2—
Angular momentum of the blade 7A (initial, at radius R)=MVR . . . [1].
Angular momentum of the blade 7A (final, at radius R/2)—
Mass of the blade 7A=M, Currently, the radius of the blade 7A=R/2.
Let's assume that the current speed of the blade 7A=VR/2.
So, the angular momentum of the blade 7A (final, at radius R/2)=MVR/2*R/2 . . . [2].

By the law of conservation of angular momentum (remember that motors 3A and 3B are off)—

Angular momentum of the blade 7A (final, at radius R/2)=Angular momentum of the blade 7A (initial, at radius R).
So, from [1] and [2]—

$$MVR / 2 * R / 2 = MVR .$$

And after the calculations VR/2=2V.

From the above calculations, at present, the blade 7A has speed 2V. Similarly, the blade 7B has speed 2V.

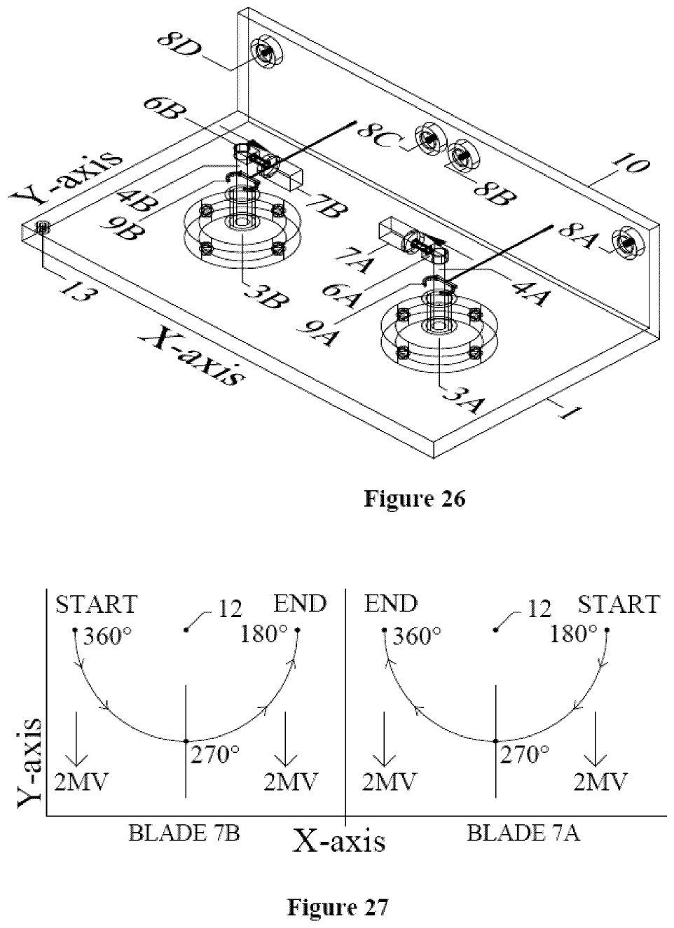

FIG. 26—Blades 7A and 7B have travelled the half-circle. Here, the instantaneous velocity of each blade 7A and 7B is +2V (Y-axis). At this moment—
The adjuster 6A starts pushing blade 7A away from the shaft 4A. And,
The adjuster 6B starts pushing blade 7B away from the shaft 4B.

FIGS. 6 and 7—In a flash, adjusters 6A and 6B pushed the blades 7A and 7B, respectively. After pushing the blades 7A and 7B, the radius of each blade 7A and 7B becomes R from R/2. At this stage, blades 7A and 7B have travelled the half-circle, as previously stated. FIG. 7 shows the path of blades' 7A and 7B half-circle travel (at radius R/2) with some angles.

The angular momentum of the blades 7A and 7B, after being radius R/2 to radius R—
Angular momentum of the blade 7A (final, at radius R)—
Mass of the blade 7A=M, Currently, the radius of the blade 7A=R.
Let's assume that the current speed of the blade 7A=V1R.
So, the angular momentum of the blade 7A (final, at radius R)=MV1R*R . . . [3].

By the law of conservation of angular momentum (remember that motors 3A and 3B are off)—

Angular momentum of the blade 7A (final, at radius R)=Angular momentum of the blade 7A (final, at radius R/2).
So, from [1], [2] and [3]—

$$MVR / 2 * R / 2 = MV 1 R * R = MVR .$$

And after the calculations V1R=V.

From the above calculations, at present, the blade 7A has speed V. Similarly, the blade 7B has speed V.

FIG. 8—Immediately after a half-circle journey by the blades 7A and 7B, the electromagnets 6AE and 6BE have turned off. Consequently, the blades 7A and 7B have separated from the adjusters 6A and 6B, respectively. After the separation, the blades 7A and 7B ended the circular motion.

After the circular motion of the blades 7A and 7B have ended; lock structures 9A and 9B lock the shafts 4A and 4B, respectively. As a result, shafts 4A, 4B stop with the adjusters 6A, 6B. Hence, they (the shaft 4A, shaft 4B, adjuster 6A and adjuster 6B) transfer their momentum to the vehicle.

After locking the shafts 4A and 4B; the momentum transferred from shaft 4A, shaft 4B, adjuster 6A and adjuster 6B to the vehicle=0. (See description of FIG. 8, half-circle split).

FIG. 9—After the circular motion of the blades 7A and 7B have ended, each blade 7A and 7B is travelling in linear motion with linear velocity +V (Y-axis) and linear momentum +MV (Y-axis). The electromagnets 8BE and 8CE have become operational.

After ending the circular motion, the linear momentum of the blades 7A and 7B=+MV+MV=+2MV (Y-axis) . . . [LM2].

FIG. 10—After travelling, the blades 7A and 7B join with the vehicle via the electromagnets 8BE and 8CE, respectively.

Currently, the linear momentum of the vehicle—

The linear momentum of the vehicle (after the joining of the blades 7A and 7B with the electromagnets 8BE and 8CE)=Linear momentum of the vehicle, from [LM1]+Linear momentum of the blades 7A and 7B, from [LM2]+Linear momentum of the vehicle (due to the centripetal reaction force generated by the blades 7A and 7B).

At this stage of the vehicle; each part of the vehicle has the same linear velocity. Right now, the first cycle completed.

From FIG. 11B and its description; even in this operation, the blades 7A and 7B generate (produce) the centripetal reaction force.

Linear momentum of the vehicle (due to the centripetal reaction force generated by the blades 7A and 7B)—

Now we will calculate the magnitude of centripetal reaction force acting on the vehicle, and we will see the effect caused by the decreased radius of the blades 7A and 7B on the vehicle.

After the radius is decreased and till the radius increases—
Radius of each blade 7A and 7B=R/2, Speed of each blade 7A and 7B=2V, Mass of each blade 7A and 7B=M. And,
The blades 7A and 7B are in a uniform circular motion.

So from the equation of centripetal force, the centripetal force of each blade 7A and 7B=M (2V) 2/(R/2).

According to Newton's third law, the centripetal reaction force generated by each blade 7A and 7B will be the same as M (2V) 2/(R/2) but in the opposite direction.

The effect of the centripetal reaction force on the vehicle towards the X and Y-axis—From figures (12A, 12B, 12C, 13A, 13B and 13C) and their descriptions—
Towards X-axis, no net centripetal reaction force works on the vehicle.
Towards Y-axis, net centripetal reaction force works on the vehicle.

The effect of the centripetal reaction force on the vehicle towards Y-axis—The magnitude of linear momentum (impulse) generated by the centripetal reaction force towards the −Y-axis—

The linear momentum provided to the vehicle by the blade 7A (due to the centripetal reaction force) “between angles 180 to 270 degrees” towards −Y-axis=Impulse=Δt*F. □Here Δt is the time taken by the blade 7A to travel “between angles 180 to 270 degrees”. The time taken by the blade 7A to travel “between angles 180 to 270 degrees”=Δt=π/2/ω (ω=2V/R/2)=π/2*R/4V.
And,
□ F is the average centripetal reaction force generated by the blade 7A “between angles 180 to 270 degrees” towards −Y-axis. The average centripetal reaction force produced by the blade 7A “between angles 180 to 270 degrees” towards −Y-axis=F.

$$F = Centripetal reaction force * ( SIN 1800 + SIN 1810 + ………… + SIN 2690 ) / 90.$$

$$F = M * ( 2 V ) 2 / ( R / 2 ) * ( SIN 1800 + SIN 1810 + ………… + SIN 2690 ) / 90.$$

$$F = M * ( 2 V ) 2 / ( R / 2 ) * ( 0.6310480562 ) .$$

$$Impulse = Δ t * F = ( π / 2 * R / 4 V ) * ( M * ( 2 V ) 2 / ( R / 2 ) ) * ( 0.6310480562 )$$

$$= π / 2 * R / 4 V * 8 MV * V / R * ( 0.6310480562 )$$

$$= 1.571428571 * ( 0.6 3104805 \; 62 ) * 2 MV$$

$$= 0.991646945 * 2 MV ≡ 2 MV .$$

The linear momentum provided to the vehicle by the blade 7A (due to the centripetal reaction force) “between angles 180 to 270 degrees” towards −Y-axis=2MV.

Similarly, the linear momentum provided to the vehicle by the blade 7B (due to the centripetal reaction force) “between angles 360 to 270 degrees” towards −Y-axis=2MV.

FIG. 27—FIG. 27 shows all the linear momentum provided to the vehicle by the blades 7A and 7B (due to the centripetal reaction force) during the half-circle travel; in the first cycle of “variable radius”. Linear momentum provided by the—
Blade 7A between angles 180 to 270 degrees towards Y-axis=−2MV.
Blade 7A between angles 270 to 360 degrees towards Y-axis=−2MV.
Blade 7B between angles 360 to 270 degrees towards Y-axis=−2MV.
Blade 7B between angles 270 to 180 degrees towards Y-axis=−2MV.

Total linear momentum provided to the vehicle by the blades 7A and 7B (due to the centripetal reaction force)=8MV (−Y-axis) . . . [LM3 variable radius]

Calculation of FIG. 10 (variable radius)—

The linear momentum of the vehicle (after the joining of the blades 7A and 7B with the electromagnets 8BE and 8CE=Linear momentum of the vehicle, from [LM1]+Linear momentum of the blades 7A and 7B, from [LM2]+Linear momentum of the vehicle (due to the centripetal reaction force generated by the blades 7A and 7B), from [LM3 variable radius]=0+2MV+(−8MV)=−6MV (Y-axis).

After completion of all the activities of the first cycle, total net linear momentum provided to the vehicle=−6MV (Y-axis). And, the invented vehicle gets a linear momentum of 6MV—
Without interacting with the mass outside the vehicle, and
Without throwing the mass from itself (the vehicle).

Now we will compare the operation “variable radius” and operation “half-circle split”. As we have seen in the operation “half-circle split”, the blades' 7A and 7B radius was constant. So if we call operation “half-circle split” as operation “constant radius”, then a good comparison would be. So for comparison, I will call operation “half-circle split” as operation “constant radius”.

Comparison between the operation “variable radius” and operation “half-circle split”/“constant radius”—

The effect of decreasing the blades' 7A and 7B radius during the blades' 7A and 7B circular motion—

By decreasing the blades' 7A and 7B radius from R to R/2, the vehicle achieves a linear momentum of 6MV instead of 2MV. In conclusion, we can say that by decreasing the blades' 7A and 7B radius (after the blades 7A and 7B have attained the angular momentum), the vehicle gets more linear momentum than operation “constant radius”.

The effect of increasing the blades' 7A and 7B radius during the blades' 7A and 7B circular motion—

When the blades' 7A and 7B radius increases from R to 2R (in the same way as the radius of the blades 7A and 7B are decreased), the vehicle achieves a linear momentum of 0MV instead of 2MV. In conclusion, we can say that by increasing the blades' 7A and 7B radius (after the blades 7A and 7B have attained the angular momentum), the vehicle gets less linear momentum than operation “constant radius”.

Now the second cycle of this operation (variable radius) is starting; in the second cycle of the operation (variable radius), we will arrange all the parts of the vehicle, so that the positions of all the parts of the vehicle are in the “beginning position” with respect to one another.

Like the previous operation (half-circle split), the second cycle of this operation (variable radius) starts from the vehicle's current state. In the second cycle, the electromagnets 8BE and 8CE have turned off. The blades 7A and 7B are pushed by the thrust structures 8B and 8C, respectively, towards the −Y-axis. Now the blades 7A and 7B are travelling. The lock structures 9A and 9B have unlocked the shafts 4A and 4B, respectively. With the help of electromagnets 6AE and 6BE; the adjusters 6A and 6B catch blades 7A and 7B, respectively. As a result, blades 7A and 7B start the circular motion in the anti-clockwise and clockwise direction, respectively. Subsequently, the second cycle process will be the same as it was in the first cycle of this operation (variable radius).

After the completion of the second cycle, the invented vehicle gets an additional linear momentum of 6MV, and, the positions of all parts of the vehicle in relation to one another are in the “beginning position” (same as the beginning of the first cycle).

For all the operations (half-circle split/full-circle split/modified start/variable radius) —The cycle will be repeated repeatedly to achieve the linear momentum required for the vehicle. After reaching the expected linear momentum, the cycle of the vehicle ends. This vehicle is in motion towards the −Y-axis.

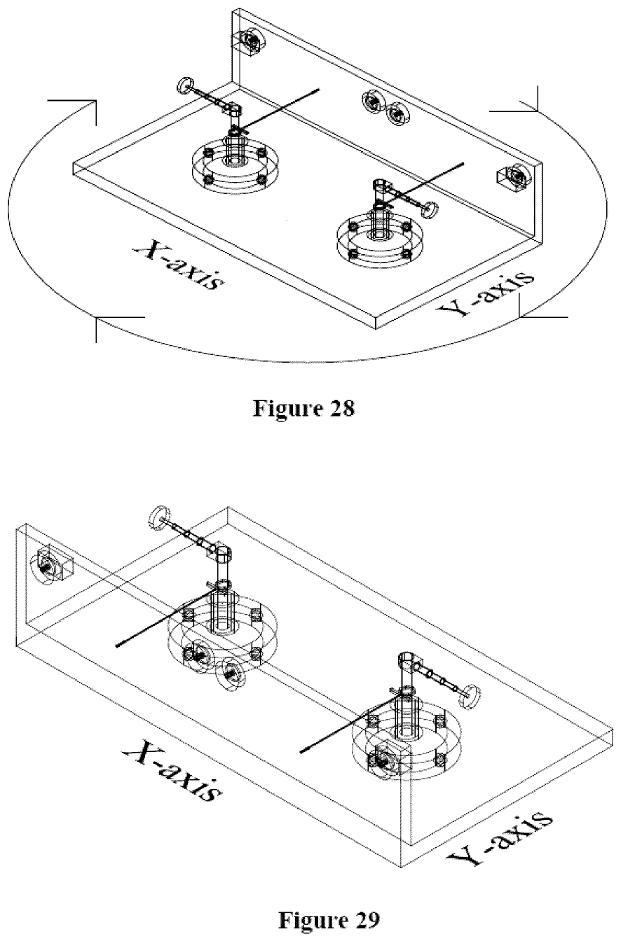

To slow down or stop the vehicle; the vehicle will be rotated until a half-circle in the clockwise or anti-clockwise direction. FIG. 28 shows the vehicle when it starts rotating in its centre. FIG. 29 shows the vehicle when it has rotated to the half-circle. After rotating until a half-circle, the vehicle stopped rotating.

The cycle of the vehicle starts again. Now the vehicle is gaining linear momentum in the opposite direction towards the +Y-axis. The cycle of the vehicle will be repeated again and again. Now the velocity of the vehicle starts decreasing (decelerating), and finally, it (the vehicle) stops.

### Conclusion, Ramifications, and Scope of Invention

Accordingly, the reader has observed that the invented vehicle gets linear momentum without throwing the mass from itself (the vehicle) in the space. Therefore no throwing mass is required by the vehicle. Because of this, the vehicle can continuously accelerate its velocity throughout its journey. As a result, the vehicle will gain a very high velocity, and it will reach very far in a short period of time.

Furthermore, the vehicle has the additional advantage in that:
It permits a vehicle, which will carry a huge mass in the space.
It permits a vehicle, which will use solar energy in the space as a fuel option.

Although the description above contains many specifications, these should not be construed as limitations on the scope of the invention, but rather as an exemplification of one preferred embodiment thereof. Many other variations are possible, for example—
1) To start the blades' 7A and 7B circular motion, the “angle” of onset can be changed from angle 180°/360° to another angle.
2) In this vehicle, the total number of motors and blades can be of any number.
3) The blades' 7A and 7B total circular journey can be shorter or longer than the half-circle journey.
4) The blades 7A and 7B may be in many parts or without parts.
5) The blade can be of any number in each circular motion. For example, if there are two blades in each circular motion—
A) Then the mass of both the blades will vary. Consequently, the centre of mass of these two blades will be away from their rotational centre. The circular motion of these two blades will generate centripetal reaction force. And there will be centripetal reaction force on the vehicle. Or,
B) If both the blades' mass is equal, then the position or arrangement of both the blades will be such that the centre of mass of both the blades moves away from their rotational centre. Now the circular motion of these two blades will generate centripetal reaction force. And there will be centripetal reaction force on the vehicle.
6) At any stage of the blades' 7A and 7B circular journey, the length of the blades' 7A and 7B radius can be changed. During the blades' 7A and 7B circular journey, the length of the blades' 7A and 7B radius can be changed once, several times or zero times.
7) In the operations, we have discussed two ways of ending the blades' 7A and 7B circular motion. But, we can end the blades' 7A and 7B circular motion in many ways, for example, let's assume, each circular path of blades 7A and 7B has electromagnet in it. And after the trip, each blade 7A and 7B collides with its respective electromagnet and sticks. After sticking with the electromagnet, the circular motion of the blades 7A and 7B ends.

Thus, the scope of the invention should be determined by the appended claims and their equivalent, rather than by the examples given.

I claim:

1) A vehicle for obtaining linear momentum without throwing the mass from the vehicle in the space, comprising:
a power source 13;
a rigid base 1;
a motor 3A and a motor 3B fitted in the rigid base 1;
a shaft 4A for the motor 3A, and a shaft 4B for the motor 3B;
an adjuster 6A fixed with the shaft 4A, and an adjuster 6B fixed with the shaft 4B, the adjuster 6A is the first part of a rotor blade 5A, and the adjuster 6B is the first part of a rotor blade 5B, the second part of the rotor blade 5A is a blade 7A, and the second part of the rotor blade 5B is a blade 7B;
a rigid body 10 fixed to the end of the rigid base 1;
a thrust structure 8A, a thrust structure 8B, a thrust structure 8C, and a thrust structure 8D fixed in the rigid body 10, at the start the thrust structures 8A and 8D give linear motion to the blades 7A and 7B, respectively, after getting the linear motion, the blades 7A and 7B are travelling;
an electromagnet 6AE and an electromagnet 6BE present on the outer surface of the adjusters 6A and 6B, respectively, after travelling, the blades 7A and 7B stick with the electromagnets 6AE and 6BE, respectively, now the blade 7A and the adjuster 6A joined via the electromagnet 6AE, and the blade 7B and the adjuster 6B joined via the electromagnet 6BE, after joining, the blades 7A and 7B start the circular motion, wherein the circular motion of the blades 7A and 7B generates centripetal reaction force.

2) The vehicle of claim 1, wherein the adjusters 6A and 6B, after achieving the angular momentum by the blades 7A and 7B, the radius of the blades 7A and 7B is decreased or increased by the adjusters 6A and 6B, respectively.

3) The vehicle of claims 1 and 2, further comprising:
a lock structure 9A and a lock structure 9B fixed in the rigid body 10, the lock structures 9A and 9B are currently unlocked, and the blades 7A and 7B are in the circular motion, now the electromagnets 6AE and 6BE turn off, consequently the blades 7A and 7B separate from the adjusters 6A and 6B, after the separation, the blades 7A and 7B ended the circular motion, and the blades 7A and 7B are travelling in linear motion, after the circular motion of the blades 7A and 7B have ended, the lock structures 9A and 9B lock the shafts 4A and 4B, respectively;
an electromagnet 8AE, an electromagnet 8BE, an electromagnet 8CE and an electromagnet 8DE present on the outer surface of the thrust structures 8A, 8B, 8C, and 8D, respectively, after travelling, the blades 7A and 7B join with the vehicle via the electromagnets 8BE and 8CE, respectively.

4) A method of operating the vehicle for obtaining linear momentum without throwing the mass from the vehicle in the space, comprising the following steps:
providing linear motion to the blades 7A and 7B, by the thrust structures 8A and 8D respectively, after getting the linear motion, the blades 7A and 7B are travelling;
joining the blades 7A and 7B with the adjuster 6A and 6B, respectively, after travelling, after joining, the blades 7A and 7B start the circular motion, wherein the circular motion of the blades 7A and 7B generates centripetal reaction force.

5) In the method of operating the vehicle of claim 4, the blades 7A and 7B can start the circular motion directly from the motors 3A and 3B, wherein the blades 7A and 7B are connected to the adjusters 6A and 6B, respectively, and the circular motion of the blades 7A and 7B generates centripetal reaction force.

6) The method of operating the vehicle of claims 4 and 5, further comprising, step of decreasing or increasing the blades' 7A and 7B radius by the adjusters 6A and 6B, respectively.

7) The method of operating the vehicle of claims 4, 5 and 6, further comprising the following steps of:
ending the blades' 7A and 7B circular motion, to end the circular motion of the blades 7A and 7B, the electromagnets 6AE and 6BE turn off, after the electromagnets 6AE and 6BE turn off, the blades 7A and 7B separate from the adjusters 6A and 6B, after the separation, the blades 7A and 7B ended the circular motion, and the blades 7A and 7B are travelling in linear motion;
locking the shafts 4A and 4B by the lock structures 9A and 9B, respectively, after the circular motion of the blades 7A and 7B have ended;
joining the blades 7A and 7B with the vehicle, after travelling.

8) The method of operating the vehicle of claims 4, 5 and 6, further comprising, step of ending the blades' 7A and 7B circular motion, to end the circular motion of the blades 7A and 7B, the motors 3A and 3B stop the shafts 4A and 4B.

9) A method of working of the vehicle for obtaining linear momentum without throwing the mass from the vehicle in the space, comprising starting the blades' 7A and 7B circular motion, wherein the circular motion of the blades 7A and 7B generates centripetal reaction force.

10) The method of working of the vehicle of claim 9, further comprising, decreasing or increasing the blades' 7A and 7B radius.

11) The method of working of the vehicle of claims 9 and 10, further comprising, ending the blades' 7A and 7B circular motion.

12) The vehicle of claim 1, configured for obtaining a linear momentum without throwing the mass from the vehicle in the space generates centripetal reaction force.

13) The vehicle of claim 1, configured for obtaining a linear momentum without throwing the mass from the vehicle in the space gets linear momentum from the blades' 7A and 7B angular momentum.

14) To obtain a linear momentum for the vehicle of claim 13 from the blades' 7A and 7B angular momentum, the circular motion of the blades 7A and 7B starts, wherein the circular motion of the blades 7A and 7B generates centripetal reaction force.

15) To obtain a linear momentum for the vehicle of claim 14 from the blades' 7A and 7B angular momentum, the circular motion of the blades 7A and 7B ends.
